(19) United States
(12) Patent Application Publication
(10) Pub. No.: US 2026/0008180 A1
(43) Pub. Date: Jan. 8, 2026

(54) DEVICE AND METHOD FOR SETTING CONVEYANCE DEVICE COORDINATE SYSTEM TO ROBOT COORDINATE SYSTEM

(71) Applicant: Fanuc Corporation, Minamitsuru-gun, Yamanashi (JP)

(72) Inventor: Taiki KATAGIRI, Minamitsuru-gun, Yamanashi (JP)

(73) Assignee: Fanuc Corporation, Minamitsuru-gun, Yamanashi (JP)

(21) Appl. No.: 18/881,463

(22) PCT Filed: Aug. 31, 2022
(86) PCT No.: PCT/JP2022/032823

§ 371 Date: Jan. 6, 2025

(51) Int. Cl. B25J 9/16; B25J 13/08; B25J 19/02

(52) U.S. Cl. CPC B25J 9/1664; B25J 9/1692; B25J 9/1697; B25J 13/08; B25J 19/023

(57) ABSTRACT

A device includes: a first indicator; a camera that acquires first image data in which the first indicator is imaged and second image data in which the first indicator conveyed after the imaging by a conveyance device is imaged; a position data acquiring unit that acquires first position data that indicates a three-dimensional position with respect to the camera in a first indicator coordinate system expressed by the first indictor captured in the first image data, and second position data that indicates a three-dimensional position with respect to the camera in a first indicator coordinate system expressed by the first indictor captured in the second image data; a conveyance direction acquiring unit that derives the conveyance direction; and a coordinate system setting unit that sets the conveyance device coordinate system to the robot coordinate system on the basis of the conveyance direction.

### CROSS REFERENCE TO RELATED APPLICATIONS

This is the U.S. National Phase application of PCT/JP2022/032823, filed Aug. 31, 2022, the disclosure of this application being incorporated herein by reference in its entirety for all purposes.

### FIELD OF THE INVENTION

The present disclosure relates to a device and a method of setting a transport device coordinate system in a robot coordinate system.

### BACKGROUND OF THE INVENTION

There is known a device configured to set a transport device coordinate system in a robot coordinate system by touching up a front end of a robot to the transport device (e.g., Patent Literature 1). There is also known a device configured to calibrate a robot coordinate system relative to a peripheral device of a robot by performing visual touch-up in which a camera images a plurality of marks provided at the peripheral device (e.g., Patent Literature 2).

### Patent Literature

PTL 1: JP 2015-174171 A

PTL 2: JP 2005-149299 A

### SUMMARY OF THE INVENTION

There is a need for a technique that enables a transport device coordinate system to be more easily set in a robot coordinate system (i.e., to perform calibration between the robot coordinate system and the transport device coordinate system).

In one aspect of the present disclosure, a device configured to set a transport device coordinate system in a robot coordinate system set to a robot configured to carry out work on a workpiece, the transport device coordinate system defining a transport direction of a transport device configured to transport the workpiece, includes a first index representing a first index coordinate system and placed on the transport device so as to be transported by the transport device, and a camera configured to acquire first image data obtained by imaging the first index, and second image data obtained by imaging the first index transported by the transport device after imaging the first image data.

The device further includes a position data acquisition unit configured to acquire first position data indicating a three-dimensional position, with respect to the camera, of the first index coordinate system represented by the first index captured in the first image data, and second position data indicating a three-dimensional position, with respect to the camera, of the first index coordinate system represented by the first index captured in the second image data, a transport direction acquisition unit configured to determine the transport direction based on the first position data and the second position data, and a coordinate system setting unit configured to set the transport device coordinate system in the robot coordinate system based on the transport direction determined by the transport direction acquisition unit.

In another aspect of the present disclosure, a method of setting a transport device coordinate system, which defines a transport direction of a transport device configured to transport a workpiece, in a robot coordinate system set to a robot configured to carry out work on the workpiece, includes placing a first index representing a first index coordinate system on the transport device so as to be transported by the transport device, acquiring first image data by imaging the first index with a camera, and acquiring second image data by imaging, with the camera, the first index transported by the transport device after imaging the first image data and acquiring second image data.

The method further includes acquiring first position data indicating a three-dimensional position, with respect to the camera, of the first index coordinate system represented by the first index captured in the first image data and second position data indicating a three-dimensional position, with respect to the camera, of the first index coordinate system represented by the first index captured in the second image data, determining the transport direction based on the first position data and the second position data, and setting the transport device coordinate system in the robot coordinate system based on the transport direction determined by a transport direction acquisition unit.

### BRIEF DESCRIPTION OF DRAWINGS

FIG. 1 is a schematic perspective view of a robot system according to an embodiment.

FIG. 2 is a block diagram of the robot system illustrated in FIG. 1.

FIG. 3 is a flowchart illustrating an example of a method of setting a transport device coordinate system in a robot coordinate system in the robot system illustrated in FIG. 1.

FIG. 4 illustrates an example of image data imaged in step S1 in FIG. 3.

FIG. 5 illustrates a state in which a first index is transported in step S3 in FIG. 3.

FIG. 6 illustrates an example of image data imaged in step S4 in FIG. 3.

FIG. 7 illustrates the transport device coordinate system set in the robot coordinate system in the robot system illustrated in FIG. 1.

FIG. 8 is a schematic perspective view of a robot system according to another embodiment.

FIG. 9 is a block diagram of the robot system illustrated in FIG. 8.

FIG. 10 illustrates the back surface side of a terminal device illustrated in FIG. 8.

FIG. 11 is a flowchart illustrating an example of a method of setting a transport device coordinate system in a robot coordinate system in the robot system illustrated in FIG. 8.

FIG. 12 illustrates an example of image data imaged in step S11 in FIG. 11.

FIG. 13 illustrates a state in which a first index is transported in step S13 in FIG. 11.

FIG. 14 illustrates an example of image data imaged in step S14 in FIG. 11.

FIG. 15 illustrates the transport device coordinate system set in the robot coordinate system in the robot system illustrated in FIG. 8.

FIG. 16 is a schematic perspective view of a robot system according to still another embodiment.

FIG. 17 is a block diagram of the robot system illustrated in FIG. 16.

FIG. 18 is a flowchart illustrating an example of a method of setting the transport device coordinate system in the robot coordinate system in the robot system illustrated in FIG. 16.

FIG. 19 illustrates an example of image data imaged in step S22 in FIG. 18.

FIG. 20 illustrates a state in which a first index is transported in step S24 in FIG. 18.

FIG. 21 illustrates an example of image data imaged in step S25 in FIG. 18.

FIG. 22 illustrates an example of image data imaged in step S27 in FIG. 18.

FIG. 23 illustrates the transport device coordinate system set in the robot coordinate system in the robot system illustrated in FIG. 16.

FIG. 24 is a flowchart illustrating another example of the method of setting the transport device coordinate system in the robot coordinate system in the robot system illustrated in FIG. 1.

### DETAILED DESCRIPTION OF EMBODIMENTS OF THE INVENTION

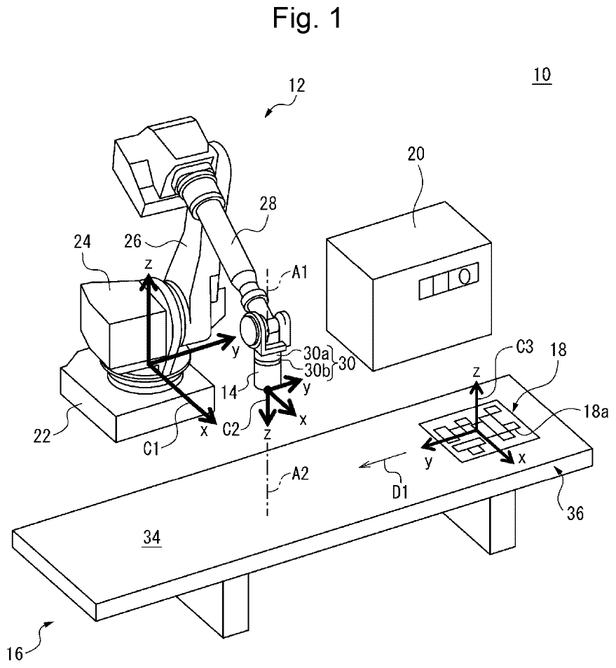

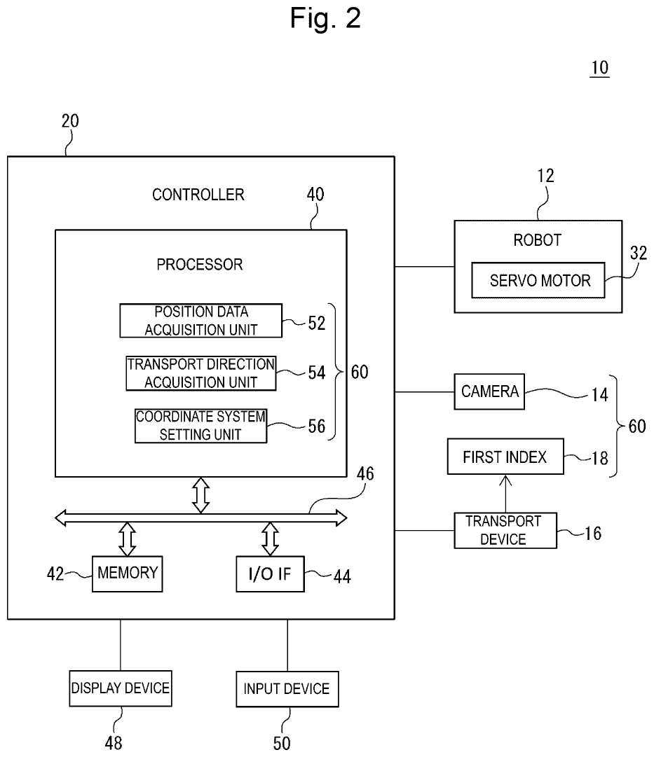

Embodiments of the present disclosure will be described in detail below based on the drawings. Note that, in the various embodiments, which will be described below, similar elements are denoted by the same signs, and redundant descriptions are omitted. First, a robot system 10 according to an embodiment will be described with reference to FIG. 1 and FIG. 2. The robot system 10 is provided with a robot 12, a camera 14, a transport device 16, a first index 18, and a controller 20.

In the present embodiment, the robot 12 is a vertical articulated robot, and carries out predetermined work (e.g., workpiece handling, welding, cutting process, laser process, or the like) on a workpiece (not illustrated). To be specific, the robot 12 includes a robot base 22, a swivel body 24, a lower arm 26, an upper arm 28, and a wrist 30.

The robot base 22 is fixed on the floor of a work cell or on an automatically guided vehicle (AGV). The swivel body 24 is provided at the robot base 22 so as to be turnable about a vertical axis. A base end portion of the lower arm 26 is provided at the swivel body 24 so as to be rotatable about a horizontal axis, and a base end portion of the upper arm 28 is provided at a distal end portion of the lower arm 26 so as to be rotatable.

The wrist 30 includes a wrist base 30a provided at a distal end portion of the upper arm 28 so as to be rotatable about two axes orthogonal to each other, and a wrist flange 30b provided at the wrist base 30a so as to be rotatable about a wrist axis A1. An end effector (robot hand, welding torch, cutting tool, laser process head, and the like) that carries out work on a workpiece is removably attached to the wrist flange 30b.

A plurality of servo motors 32 are individually provided at the robot base 22, the swivel body 24, the lower arm 26, the upper arm 28, and the wrist 30 (FIG. 2). These servo motors 32 rotate respective movable components of the robot 12 (i.e., the swivel body 24, the lower arm 26, the upper arm 28, the wrist 30, and the wrist flange 30b) in response to a command from the controller 20, thereby moving the end effector (not illustrated) attached to the wrist flange 30b to a freely selected position.

In the present embodiment, the camera 14 is removably attached to the wrist flange 30b instead of the end effector. The camera 14 is a two-dimensional camera including an image sensor (CMOS, CCD, or the like) and an optical lens (a collimator lens, a focus lens, or the like) that guides a subject image to the image sensor, and images a subject in response to a command from the controller 20. The camera 14 captures the subject image along an optical axis A2 and forms the subject image at the image sensor with the optical lens to acquire image data ID of the subject image. In the present embodiment, the camera 14 is moved to a freely selected position by the robot 12.

The transport device 16 is arranged around the robot 12, and transports the workpiece in a transport direction D1. For example, the transport device 16 is a belt conveyor or the like, and includes a transport surface 34 on which the workpiece is placed, and a driving mechanism 36 that moves the transport surface 34 in the transport direction D1. The transport surface 34 may be defined by an outer surface of a timing belt.

In addition, the driving mechanism 36 may include a servo motor (not illustrated) that drives the timing belt (i.e., the transport surface 34) in response to a command from the controller 20. The transport device 16 is arranged such that at least a part of the transport surface 34 is within a work range of the robot 12 (i.e., within a range in which the end effector can be positioned).

The controller 20 controls the robot 12, the camera 14, and the transport device 16. Specifically, as illustrated in FIG. 2, the controller 20 is a computer including a processor 40, a memory 42, and an I/O interface 44. The processor 40 includes a CPU or a GPU, is communicably connected to the memory 42 and the I/O interface 44 via a bus 46, and executes an arithmetic process to implement a function of setting a transport device coordinate system, which will be described below, while communicating with these components.

The memory 42 includes a RAM, a ROM or the like, and temporarily or permanently stores various types of data. The memory 42 can be constituted by a computer-readable storage medium such as a volatile memory, a nonvolatile memory, a magnetic storage medium, or an optical storage medium. The I/O interface 44 includes, for example, an Ethernet (trade name) port, a USB port, an optical fiber connector, or an HDMI (trade name) terminal, and performs wired or wireless data communication with an external apparatus under a command from the processor 40. In the present embodiment, each of the servo motors 32 of the robot 12, the camera 14, and the transport device 16 (specifically, the driving mechanism 36) are communicably connected to the I/O interface 44.

In addition, the controller 20 is provided with a display device 48 and an input device 50. The display device 48 and the input device 50 are communicably connected to the I/O interface 44. The display device 48 includes a liquid crystal display or an organic EL display and displays various types of data to be visually recognized under a command from the processor 40.

The input device 50 includes a push button, a switch, a keyboard, a mouse, a touch panel, or the like, and receives input of data from an operator. Note that the display device 48 and the input device 50 may be integrally incorporated in a housing of the controller 20, or may be externally attached to the housing as one computer (PC or the like) separated from the housing of the controller 20.

As illustrated in FIG. 1, a robot coordinate system C1 is set to the robot 12. The robot coordinate system C1 is a coordinate system for automatically controlling an operation of each of movable elements of the robot 12. In the present embodiment, the robot coordinate system C1 is fixed to the robot base 22 such that the origin is arranged at a center of the robot base 22 and the z-axis is parallel to (specifically, coincides with) a swiveling axis of the swivel body 24.

On the other hand, a camera coordinate system C2 is set at the camera 14. In the present embodiment, the camera coordinate system C2 is arranged such that the origin is at a center of the image sensor of the camera 14, and is set at the camera 14 such that the z-axis is parallel to (specifically, coincides with) an optical axis A2. Note that the camera 14 may be attached to the wrist flange 30b such that the optical axis A2 is parallel to (or coincides with) the wrist axis A1.

The camera coordinate system C2 defines coordinates of each pixel of image data ID (or the image sensor) imaged with the camera 14. Here, in the present embodiment, a position of the camera 14 in the robot coordinate system C1 (i.e., a position of the wrist flange 30b) is known. Therefore, a positional relationship R_{1_2_n} between the robot coordinate system C1 and the camera coordinate system C2 of the camera 14 arranged at a freely selected position PSn of the robot coordinate system C1 is known.

Thus, coordinates Q (X, Y, Z, W, P, R) of the camera coordinate system C2 in the robot coordinate system C1 are known, and coordinates of the robot coordinate system C1 and coordinates of the camera coordinate system C2 can be mutually converted to each other through a known conversion matrix M_{1_2_n} (simultaneous conversion matrix, Jacobian matrix, or the like). The controller 20 holds the parameters of the conversion matrix M_{1_2_n}, the coordinates of the camera coordinate system C2 in the robot coordinate system C1, and the like as data indicating the positional relationship R_{1_2_n}, and stores these parameters and coordinates in the memory 42.

Here, when the robot 12 and the transport device 16 cooperate with each other to carry out work on a workpiece, it is necessary to set the transport device coordinate system in the robot coordinate system C1. The transport device coordinate system is set for the transport device 16 and defines a position of the transport surface 34 and the transport direction D1. The first index 18 is used to set the transport device coordinate system in the robot coordinate system C1 (i.e., to make the positional relationship between the robot coordinate system C1 and the transport device coordinate system known).

To be specific, the first index 18 is made of a flat paper material, a flat plate material, or the like, and a pattern 18a is displayed so as to be visually recognized on the surface thereof. The pattern 18a includes, for example, a figure constituted by a plurality of lines or curves, or a dot pattern. The first index 18 is configured so as to represent the first index coordinate system C3 by the pattern 18a, and is placed on the transport surface 34 of the transport device 16 so as to be transported by the transport device 16. Note that the first index 18 may be fixed to the transport surface 34 by using a fastener (bolt or the like) or a jig so as to be immovable on the transport surface 34. Alternatively, the pattern 18a of the first index 18 may be formed directly on the transport surface 34 by printing, engraving, or the like.

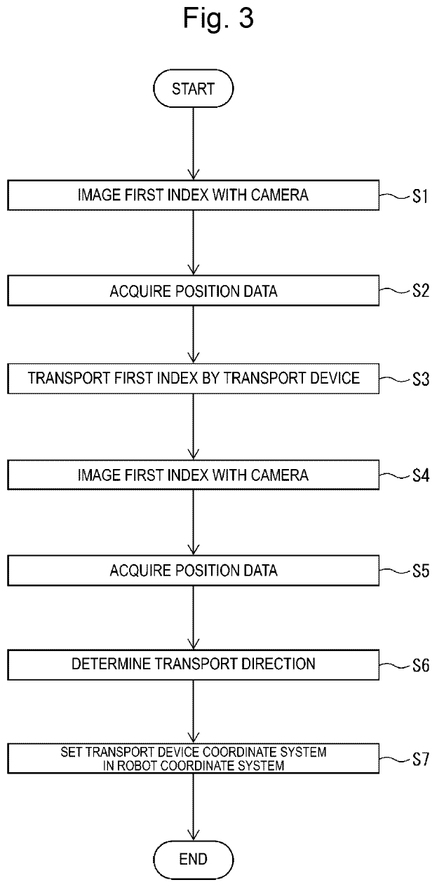

Next, a method in which the transport device coordinate system is set in the robot coordinate system C1 in the robot system 10 will be described with reference to FIG. 3. Before starting a procedure of FIG. 3, an operator places the first index 18 on the transport surface 34 of the transport device 16 as illustrated in FIG. 1. At this time, the operator may arrange the first index 18 within the work range of the robot 12. The operator operates the input device 50 to give a coordinate system setting command to the processor 40 after placing the first index 18. The processor 40 starts the procedure illustrated in FIG. 3 when receiving the coordinate system setting command.

In step S1, the processor 40 images the first index 18 with the camera 14. To be specific, the processor 40 causes the robot 12 to operate and to move the camera 14 to an imaging position PS1 at which the first index 18 can be included in the field of view of the camera 14. Then, the processor 40 causes the camera 14 to operate and to image the first index 18.

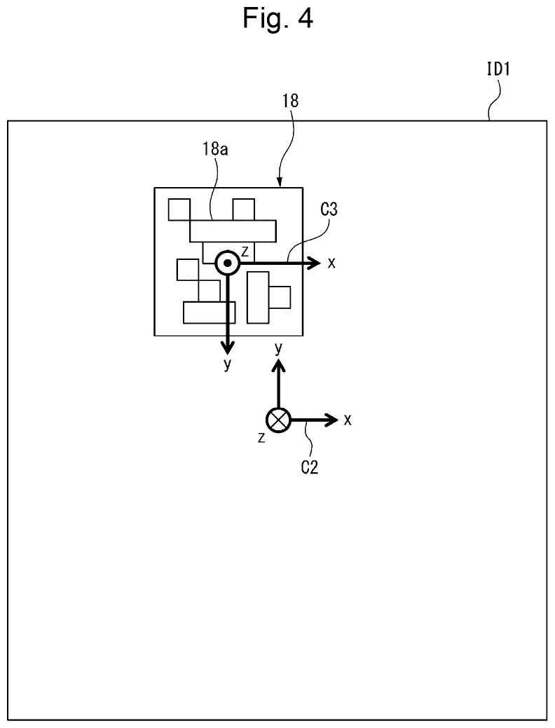

An example of image data ID1 imaged with the camera 14 in step S1 is illustrated in FIG. 4. Each pixel of the image data ID1 is represented as coordinates of the camera coordinate system C2, and the first index 18 has been captured in the image data ID1. The camera 14 acquires the image data ID1 (first image data) obtained by imaging the first index 18 in this way and supplies the image data ID1 to the processor 40.

In step S2, the processor 40 acquires position data PD1 (first position data) indicating a three-dimensional position of the first index coordinate system C3 represented by the first index 18 captured in the image data ID1 with respect to the camera 14. Here, the pattern 18a of the first index 18 captured in the image data ID1 is configured so as to represent the three-dimensional position of the first index coordinate system C3 in the camera coordinate system C2 set in the camera 14 at the time of imaging the image data ID1.

The processor 40 executes an image analysis program PG1 (or an image analysis application) for reading the first index coordinate system C3 from the pattern 18a to analyze the pattern 18a of the first index 18 captured in the image data ID1, and specifies the first index coordinate system C3 represented by the first index 18 in the image data ID1. Then, the processor 40 acquires coordinates Q1 (X1, Y1, Z1, W1, P1, R1) of the specified first index coordinate system C3 in the camera coordinate system C2.

Among the coordinates Q1, the coordinates (X1, Y1, Z1) indicate the origin position of the first index coordinate system C3 in the camera coordinate system C2 of FIG. 4, and the coordinates (W1, P1, R1) indicate an orientation (i.e., directions of the axes) of the first index coordinate system C3 (so-called yaw, pitch, and roll) with respect to the camera coordinate system C2 of FIG. 4.

As described above, the coordinates Q1 indicate the three-dimensional position of the first index coordinate system C3 in the camera coordinate system C2 of FIG. 4, i.e., the three-dimensional position of the first index coordinate system C3 with respect to the camera 14 at the time of imaging the image data ID1. That is, in the present description, the “position” may indicate a position and an orientation. In step S2, the processor 40 acquires the coordinates Q1 as the position data PD1. Consequently, the processor 40 serves as a position data acquisition unit 52 (FIG. 2) configured to acquire the position data PD1 (specifically, the coordinates Q1).

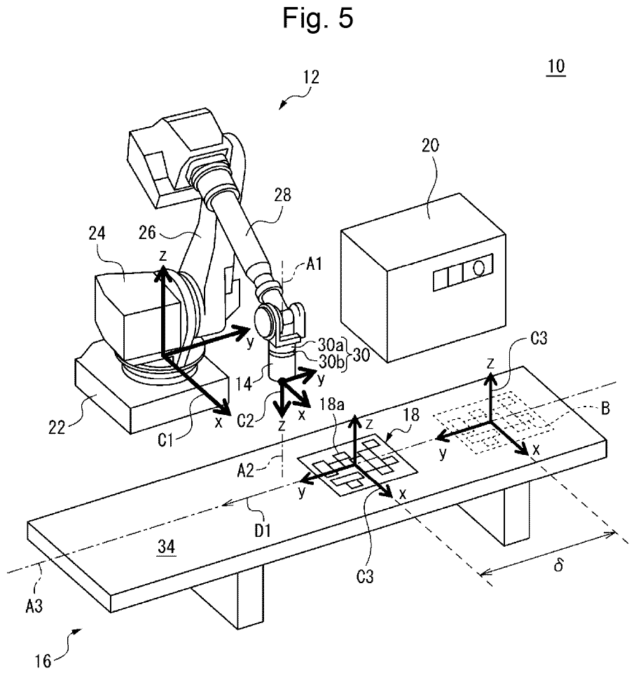

In step S3, the processor 40 transports the first index 18 by using the transport device 16. To be specific, the processor 40 causes the driving mechanism 36 of the transport device 16 to operate and to transport the transport surface 34 in the transport direction D1 by a predetermined distance 8. As a result, as illustrated in FIG. 5, the first index 18 is transported by the distance 8 in the transport direction D1 from the position at the time of imaging the image data ID1. Note that in FIG. 5, for ease of understanding, the position of the first index 18 at the time of imaging the image data ID1 is indicated by a dotted line B, and the first index coordinate system C3 represented by the first index 18 is also illustrated.

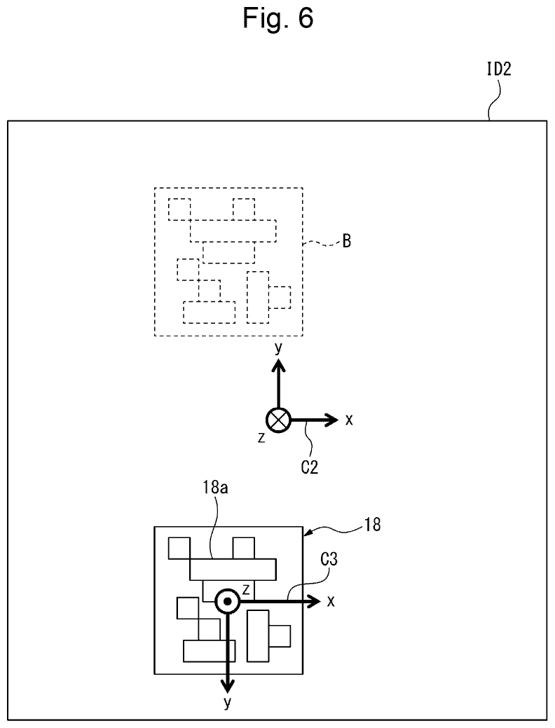

In step S4, the processor 40 images the first index 18 with the camera 14. Here, in the present embodiment, in step S4, the processor 40 causes the camera 14 to image the first index 18 in a state in which the camera 14 is arranged at the same imaging position PS1 as that in step S1 described above. That is, the imaging position PS1 is determined in the robot coordinate system C1 such that the first index 18 before and after the transport in step S3 can be included in the field of view of the camera 14. In step S4, an example of image data ID2 imaged with the camera 14 is illustrated in FIG. 6. In the image data ID2, the first index 18 after the transport in step S3 has been captured. The camera 14 acquires the image data ID2 (second image data) obtained by imaging the first index 18 after the transport, and supplies the image data ID2 to the processor 40.

In step S5, the processor 40 functions as the position data acquisition unit 52 to acquire position data PD2 (second position data) indicating a three-dimensional position of the first index coordinate system C3 represented by the first index 18 captured in image data ID2 with respect to the camera 14. To be specific, the processor 40 executes the image analysis program PG1 as in the above-described step S2 to acquire coordinates Q2 (X2, Y2, Z2, W2, P2, R2), in the camera coordinate system C2, of the first index coordinate system C3 represented by the first index 18 captured in the image data ID2. The coordinates Q2 indicate a three-dimensional position of the first index coordinate system C3 with respect to the camera 14 at the time of imaging the image data ID2. Thus, in step S5, the processor 40 acquires the coordinates Q2 as the position data PD2.

In step S6, the processor 40 determines the transport direction D1 based on pieces of position data PD1 and PD2. To be specific, the processor 40 uses the known positional relationship R_{1_2_1} between the robot coordinate system C1 and the camera coordinate system C2 arranged at the imaging position PS1 (to be specific, the conversion matrix M_{1_2_1}) to convert the coordinates Q1 (X1, Y1, Z1, W1, P1, R1) in the camera coordinate system C2 acquired as the position data PD1 in the above-described step S2 into coordinates Q3 (X3, Y3, Z3, W3, P3, R3) in the robot coordinate system C1. The coordinates Q3 indicate a three-dimensional position (to be specific, a three-dimensional position and orientation), in the robot coordinate system C1, of the first index coordinate system C3 represented by the first index C1 at the time of imaging the image data ID1 (i.e., at the time of performing step S1).

Similarly, by using the positional relationship R_{1_2_1}, the processor 40 converts the coordinates Q2 (X2, Y2, Z2, W2, P2, R2) of the camera coordinate system C2 acquired as the position data PD2 in the above-described step S5 into coordinates Q4 (X4, Y4, Z4, W4, P4, R4) of the robot coordinate system C1. The coordinates Q4 indicate a three-dimensional position in the robot coordinate system C1 of the first index coordinate system C3 represented by the first index C1 at the time of imaging of the image data ID2 (i.e., at the time of performing step S4).

Then, the processor 40 calculates a vector VT_{3_4} from the coordinates (X3, Y3, Z3) among the coordinates Q3 to the coordinates (X4, Y4, Z4) among the coordinates Q4. The vector VT_{3_4} coincides with an axis A3 connecting the coordinates (X3, Y3, Z3) and the coordinates (X4, Y4, Z4), and indicates the position of the vector of the transport direction D1 in the robot coordinate system C1.

The vector VT_{3_4} (or the axis A3) indicates a locus in the robot coordinate system C1 of the origin of the first index coordinate system C3 moved in the transport direction DI in step S3, and can be regarded as being arranged on the transport surface 34 (or at a position above the transport surface 34 by a known distance). In other words, the vector VT_{3_4} (or the axis A3) indicates the transport direction D1 in the robot coordinate system C1, as well as being data indicating the position of the transport surface 34 in the robot coordinate system C1.

In this way, the processor 40 acquires the vector VT_{3_4} (or the axis A3) as the transport direction D1 in the robot coordinate system C1 based on the pieces of position data PD1 and PD2. Thus, in the present embodiment, the processor 40 functions as a transport direction acquisition unit 54 (FIG. 2) that determines the transport direction DI based on the pieces of position data PD1 and PD2.

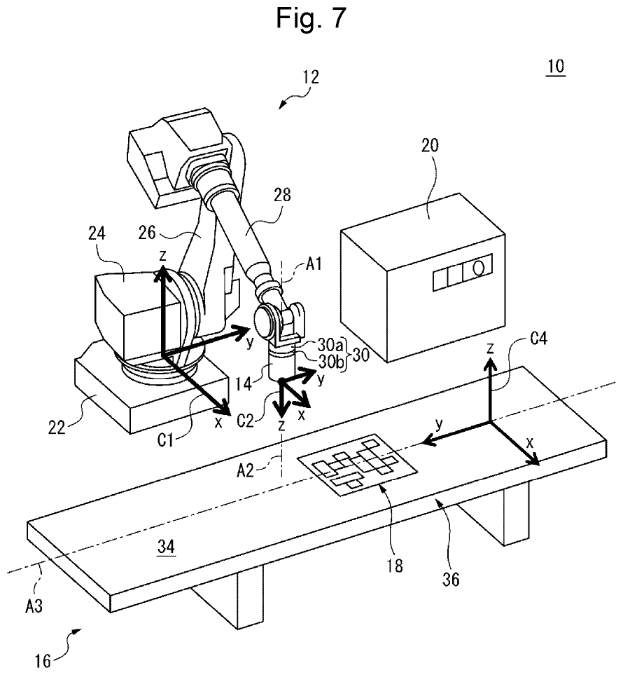

In step S7, the processor 40 sets the transport device coordinate system C4 (FIG. 7) in the robot coordinate system C1 based on the transport direction DI determined in step S6. To be specific, the processor 40 determines the transport direction D1 (to be specific, the vector VT_{3_4}) determined in step S6 as the y-axis positive direction of the transport device coordinate system C4.

In addition, the processor 40 determines the z-axis direction of the transport device coordinate system C4 as a direction parallel to the y-z plane of the robot coordinate system C1 and orthogonal to the y-axis of the transport device coordinate system C4 determined as described above. Then, the processor 40 determines the x-axis direction of the transport device coordinate system C4 as a direction orthogonal to the y-axis and the z-axis of the transport device coordinate system C4.

At this time, the processor 40 may randomly determine the z-axis positive direction and the x-axis positive direction of the transport device coordinate system C4. Alternatively, the operator may operate the input device 50 to input setting information in the z-axis positive direction or the x-axis positive direction in advance, and the processor 40 may determine the z-axis positive direction or the x-axis positive direction of the transport device coordinate system C4 in response to the setting information.

The setting information may include information defining the z-axis positive direction of the transport device coordinate system C4 as a direction close to the z-axis positive direction (i.e., vertically upward direction) of the robot coordinate system C1 (i.e., a direction in which an inner product of the two described above becomes larger). Alternatively, the setting information may include information defining the x-axis positive direction of the transport device coordinate system C4 as the direction opposite to the robot coordinate system C1.

In addition, the processor 40 determines the origin of the transport device coordinate system C4 in the robot coordinate system C1. As an example, the processor 40 determines the above-described coordinates Q3 (X1, Y1, Z1) or the coordinates Q4 (X4, Y4, Z4) as the origin of the transport device coordinate system C4. As another example, when the axis A3 is acquired in step S6 described above, the processor 40 may determine the origin of the transport device coordinate system C4 as a predetermined position on the axis A3 (e.g., an upstream end or a downstream end of the transport surface 34, or a center, an upstream end, or a downstream end of the work range of the robot 12).

Note that the above-described coordinates Q3 indicate the position and the orientation (the directions of the axes) of the first index coordinate system C3 in the robot coordinate system C1 before the transport in step S3. In step S7, the processor 40 may correct the coordinates (W3, P3, R3) indicating the orientation among the coordinates Q3 such that the y-axis positive direction of the first index coordinate system C3 before the transport coincides with the transport direction D1 (vector VT_{3_4}), thereby determining coordinates (W3c, P3c, R3c) of a new orientation. Then, the processor 40 may determine the coordinates (W3c, P3c, R3c) of the new orientation as the directions of the axes of the transport device coordinate system C4.

Similarly, the processor 40 may determine coordinates (W4c, P4c, R4c) of the new orientation by correcting the coordinates (W4, P4, R4) indicating the orientation among the coordinates Q4 indicating the position and the orientation of the first index coordinate system C3 in the robot coordinate system C1 after the transport in step S3. Then, the processor 40 may determine the coordinates (W4c, P4c, R4c) of the new orientation as the directions of the axes of the transport device coordinate system C4.

Thus, as illustrated in FIG. 7, the transport device coordinate system C4 is set in the robot coordinate system C1. The transport device coordinate system C4 is fixed in the robot coordinate system C1, and the y-axis positive direction thereof indicates the transport direction D1 in the robot coordinate system C1 with high accuracy. Then, the x-y plane (or the origin) of the transport device coordinate system C4 indicates the position of the transport surface 34 in the robot coordinate system C1. Thus, in the present embodiment, the processor 40 functions as a coordinate system setting unit 56 (FIG. 2) that sets the transport device coordinate system C4 in the robot coordinate system C1, based on the transport direction D1.

As described above, the processor 40 functions as the position data acquisition unit 52, the transport direction acquisition unit 54, and the coordinate system setting unit 56, and sets the transport device coordinate system C4 in the robot coordinate system C1 based on the pieces of image data ID1 and ID2 obtained by imaging the first index 18 with the camera 14. Thus, the camera 14, the first index 18, the position data acquisition unit 52, the transport direction acquisition unit 54, and the coordinate system setting unit 56 constitute a device 60 (FIG. 2) that sets the transport device coordinate system C4 in the robot coordinate system C1.

In the device 60, the first index 18 representing the first index coordinate system C3 is placed at the transport device 16 (specifically, on the transport surface 34) so as to be transported by the transport device 16. Further, the camera acquires the first image data ID1 (FIG. 4) obtained by imaging the first index 18 and the second image data ID2 (FIG. 6) obtained by imaging the first index 18 transported by the transport device 16 in step S3 after imaging the first image data ID1 (steps S1 and S4).

Additionally, the position data acquisition unit 52 acquires the first position data PD1 (to be specific, the coordinates Q1) indicating the three-dimensional position of the first index coordinate system C4 represented by the first index 18 captured in the first image data ID1 with respect to the camera 14 (to be specific, the camera coordinate system C2) (step S2). Next, the position data acquisition unit 52 acquires the second position data PD2 (to be specific, the coordinates Q2) indicating the three-dimensional position of the first index coordinate system C3 represented by the first index 18 captured in the second image data ID2 with respect to the camera 14 (camera coordinate system C2) (step S5).

Then, based on the first position data PD1 and the second position data PD2, the transport direction acquisition unit 54 determines the transport direction D1 (to be specific, the vector VT_{3_4} or the axis A3) in the robot coordinate system C1 (step S6). The coordinate system setting unit 56 sets the transport device coordinate system C4 in the robot coordinate system C1 based on the transport direction D1 determined by the transport direction acquisition unit 54 (step S7).

With this configuration, the transport device coordinate system C4 can be set in the robot coordinate system C1 by imaging the first index 18 transported by the transport device 16 with the camera 14 without touching up a front end (wrist flange 30b or end effector) of the robot 12 to the transport device 16 or performing visual touch-up for imaging a plurality of marks provided at the transport device 16 with the camera 14. With this configuration, it is possible to more easily set (i.e., perform calibration) the transport device coordinate system C4 in the robot coordinate system C1.

Additionally, in the device 60, the first index 18 includes the pattern 18a representing the three-dimensional position of the first index coordinate system C3 in the camera coordinate system C2 set for the camera 14 that has imaged the image data ID. With this configuration, the first index coordinate system C3 can be more effectively represented in the camera coordinate system C2 by using the pattern 18a of the first index 18 captured in the image data ID.

Note that in the present embodiment, the case has been described in which in step S4, the first index 18 is imaged in a state in which the camera 14 is arranged at the same imaging position PS1 as that in step S1. However, the present disclosure is not limited thereto, and in step S4, the processor 40 may move the camera 14 from the imaging position PSI to an imaging position PS2 and acquire the image data ID2′ obtained by imaging the first index 18 at the imaging position PS2.

In this case, the processor 40 functions as the position data acquisition unit 52 in step S5, and acquires the coordinates Q2′ (X2′, Y2′, Z2′, W2′, P2′, R2′), in the camera coordinate system C2, of the first index coordinate system C3 specified in the image data ID2′. Then, in step S7, the processor 40 converts the coordinates Q2′ into the coordinates Q4 (X4, Y4, Z4, W4, P4, R4) in the robot coordinate system C1 by using the known positional relationship R_{1_2_2} (to be specific, the conversion matrix M_{1_2_2}) between the robot coordinate system C1 and the camera coordinate system C2 of the camera 14 arranged at the imaging position PS2.

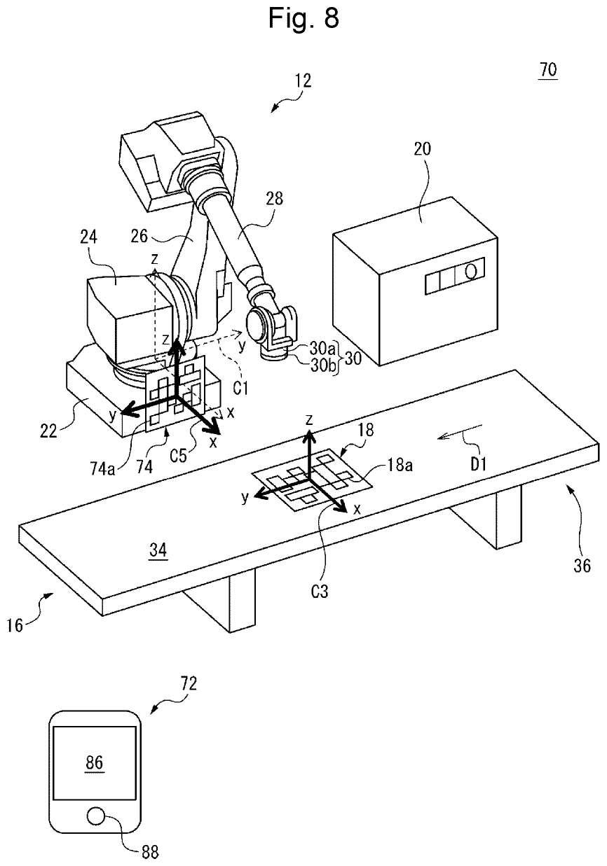

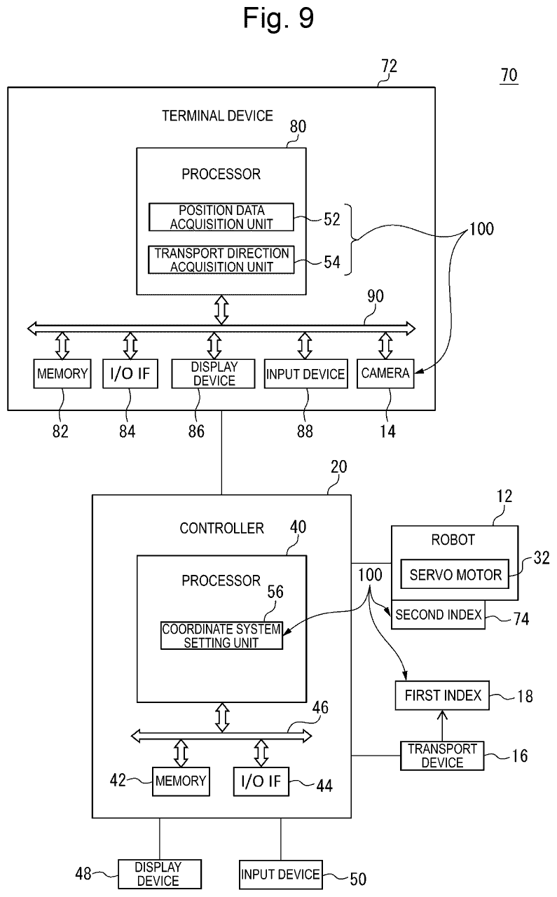

Next, a robot system 70 according to another embodiment will be described with reference to FIG. 8 and FIG. 9. The robot system 70 differs from the robot system 10 described above in that the robot system 70 further includes a terminal device 72 and a second index 74. The terminal device 72 is, for example, a portable computer such as a smartphone, a tablet terminal device, or a laptop PC, and can be carried by an operator with a hand.

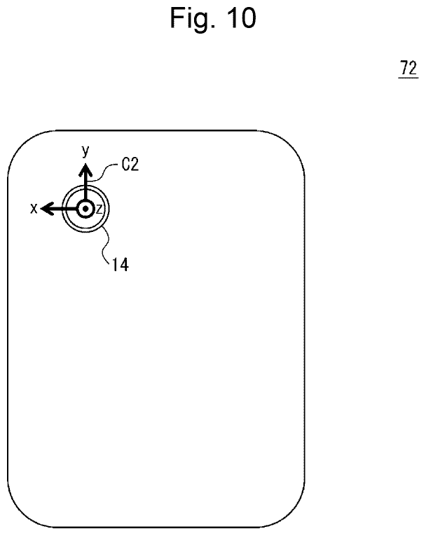

Specifically, as illustrated in FIG. 9, the terminal device 72 includes a processor 80, a memory 82, an I/O interface 84, a display device 86, an input device 88, and the camera 14. The display device 86 and the input device 88 are integrally provided at a surface of the terminal device 72 as illustrated in FIG. 8, while the camera 14 is integrally provided at the back surface of the terminal device 72 as illustrated in FIG. 10. At the camera 14, the camera coordinate system C2 is set as in the above-described embodiment.

The processor 80 is communicably connected to the memory 82, the I/O interface 84, the display device 86, the input device 88, and the camera 14 via the bus 90, and performs an arithmetic process for achieving a function that sets a transport device coordinate system, which will be described later, while communicating with these components. The I/O interface 84 is communicably connected in a wired or wireless manner to the I/O interface 44 of the controller 20.

Note that the configurations of the processor 80, the memory 82, the I/O interface 84, the display device 86, and the input device 88 are similar to those of the processor 40, the memory 42, the I/O interface 44, the display device 48, and the input device 50 described above, and as such duplicate descriptions will be omitted.

The second index 74 is used together with the first index 18 in order to set the transport device coordinate system C4 in the robot coordinate system C1. To be specific, as illustrated in FIG. 8, the second index 74 is made of a flat paper material, a plate material, or the like, similarly to the first index 18 described above, and a pattern 74a is displayed on a surface thereof so as to be visually recognized.

The pattern 74a includes, for example, a figure constituted by a plurality of lines or curves, or a dot pattern. The second index 74 is fixed at the robot 12 (e.g., the robot base 22), and is configured so as to represent a second index coordinate system C5 by the pattern 74a. Here, the second index 74 is positioned at the robot 12 such that a positional relationship R_{1_5} between the second index coordinate system C5 represented by the pattern 74a and the robot coordinate system C1 is known. Thus, the coordinates of the robot coordinate system C1 and the coordinates of the second index coordinate system C5 can be converted into each other through the known conversion matrix M_{1_5} (simultaneous conversion matrix, Jacobian matrix, or the like). In the present embodiment, the controller 20 holds parameters of the conversion matrix M_{1_5}, the coordinates of the second index coordinate system C5 in the robot coordinate system C1, and the like as data indicating the positional relationship R_{1_5}, and stores the data in the memory 42. Note that in FIG. 8, the robot coordinate system C1 is indicated by a dotted line for ease of understanding.

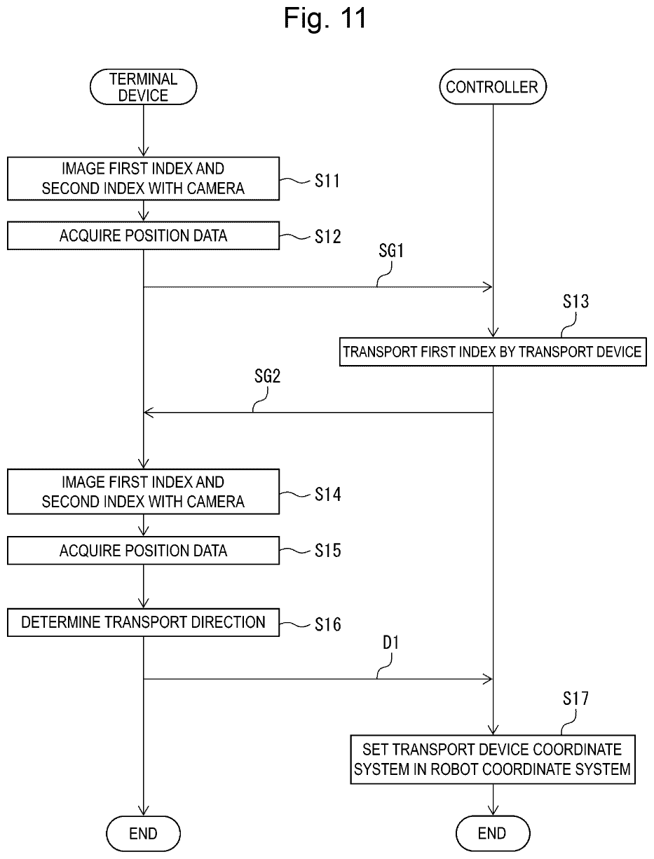

Next, a method of setting the transport device coordinate system C4 in the robot coordinate system C1 in the robot system 70 will be described with reference to FIG. 11. As in the above-described embodiment, the operator places the first index 18 on the transport surface 34 of the transport device 16 before starting the procedure of FIG. 11.

In step S11, the processor 80 of the terminal device 72 causes the camera 14 to image the first index 18 and the second index 74. To be specific, the operator arranges the terminal device 72 at an imaging position PS3 at which the first index and the second index 74 can be included in the field of view of the camera 14 of the terminal device 72. At this time, the processor 80 may display the image data ID continuously imaged with the camera 14 on the display device 86 of the terminal device 72 in real time (so-called live view display).

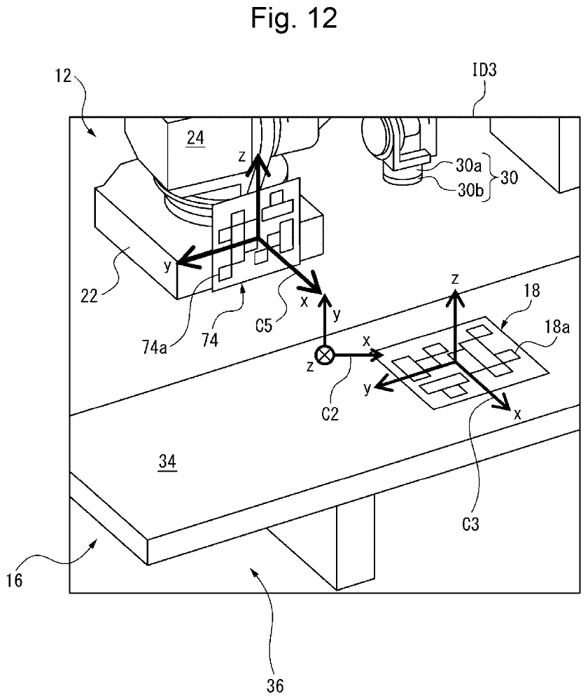

Then, the operator operates the input device 88 of the terminal device 72 arranged at the imaging position PS3 to give an imaging command to the processor 80. In response to the imaging command, the processor 80 causes the camera 14 to operate and to image the first index and the second index 74. FIG. 12 illustrates an example of image data ID3 imaged with the camera 14 in step S11.

The camera 14 acquires the image data ID3 (first image data) obtained by imaging the first index 18 and the second index as described above, and supplies the image data ID3 to the processor 80. Note that in imaging of the image data ID3, the operator may hold the terminal device 72 with a hand, or may fix the terminal device 72 at a fixed point by using a fixture (a tripod, a stand, or the like).

In step S12, the processor 80 functions as the position data acquisition unit 52 (FIG. 9), and acquires position data PD3 (first position data) indicating the three-dimensional position of the first index coordinate system C3 represented by the first index 18 captured in the image data ID3 with respect to the camera 14. To be specific, the processor 80 executes the above-described image analysis program PG1 to analyze the pattern 18a of the first index 18 captured in the image data ID3, and specifies the first index coordinate system C3 represented by the first index 18 in the image data ID3. The image analysis program PG1 is stored in the memory 82 in advance.

Then, the processor 80 acquires coordinates Q5 (X5, Y5, Z5, W5, P5, R5) of the specified first index coordinate system C3 in the camera coordinate system C2. The coordinates Q5 indicate a three-dimensional position of the first index coordinate system C3 with respect to the camera 14 at the time of imaging of the image data ID3. In step S12, the processor 80 acquires the coordinates Q5 as the position data PD3.

In addition, the processor 80 functions as the position data acquisition unit 52, and acquires position data PD4 (third position data) indicating a three-dimensional position of the second index coordinate system C5 represented by the second index 74 captured in the image data ID3 with respect to the camera 14. To be specific, the processor 80 executes the image analysis program PG1 to analyze the pattern 74a of the second index 74 captured in the image data ID3, and specifies the second index coordinate system C5 represented by the second index 74 in the image data ID3.

Then, the processor 80 acquires the coordinates Q6 (X6, Y6, Z6, W6, P6, R6) of the specified second index coordinate system C5 in the camera coordinate system C2. The coordinates Q6 indicate the three-dimensional position of the second index coordinate system C5 with respect to the camera 14 at the time of imaging of the image data ID3. In step S12, the processor 80 acquires the coordinates Q6 as the position data PD4. In this way, in step S12, the processor 80 acquires the position data PD4 of the second index coordinate system C5 together with the position data PD3 of the first index coordinate system C3.

Upon completion of step S12, the processor 80 transmits a completion signal SG1 to the controller 20. The processor 40 of the controller 20 performs step S13 in response to the completion signal SG1. To be specific, in step S13, the processor 40 causes the transport device 16 to operate and to transport the first index 18 by the distance 8 in the transport direction D1, as in step S3 described above.

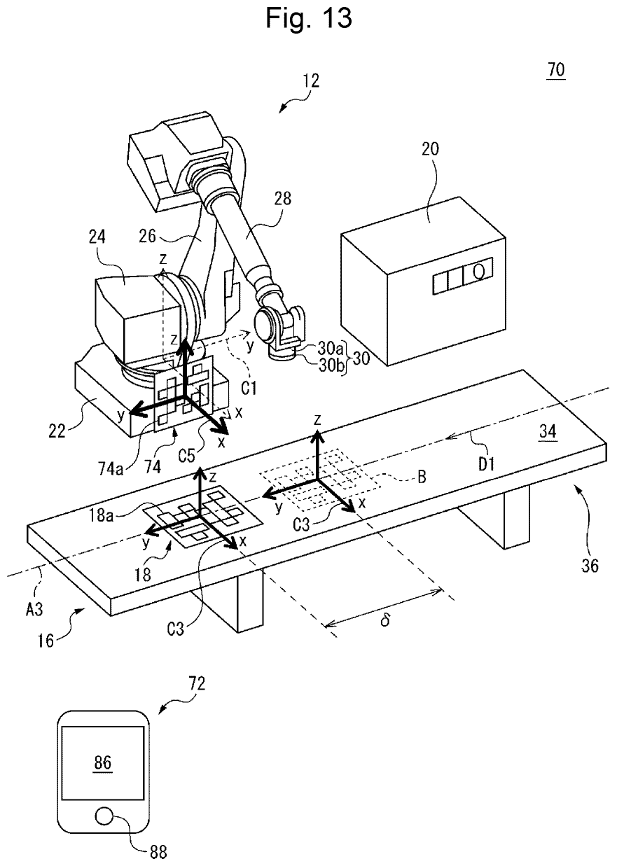

Note that when receiving the completion signal SG1, the processor 40 may generate a notification signal NS1 notifying that the first index 18 needs to be transported by the transport device 16 and output the notification signal NS1 to the display device 48 (or a speaker provided at the controller 20). Then, when the operator recognizes the notification signal NS1, the operator may perform step S13 and manually operate the transport device 16 to transport the first index 18. FIG. 13 illustrates a state in which step S13 is completed. Note that in FIG. 13, for ease of understanding, the position of the first index 18 at the time of imaging of the image data ID3 is indicated by a dotted line B, and the first index coordinate system C3 represented by the first index 18 is also illustrated.

After completion of step S13, the processor 40 transmits a completion signal SG2 to the terminal device 72. Upon receiving the completion signal SG2, the processor 80 of the terminal device 72 performs step S14. At this time, the processor 80 may generate a notification signal NS2 notifying that the first index 18 and the second index 74 need to be imaged again with the camera 14, and output the notification signal NS2 to the display device 86 (or a speaker provided at the terminal device 72).

In step S14, the processor 80 of the terminal device 72 causes the camera 14 to image the first index 18 and the second index 74. To be specific, when the operator recognizes the notification signal NS2 output to the display device 86 (or the speaker of the terminal device 72), the operator arranges the terminal device 72 at an imaging position PS4 at which the first index and the second index 74 can be included in the field of view of the camera 14. The imaging position PS4 may be different from or the same as the imaging position PS3 of step S11 described above. Additionally, at this time, the processor 80 may perform the above-described live view display.

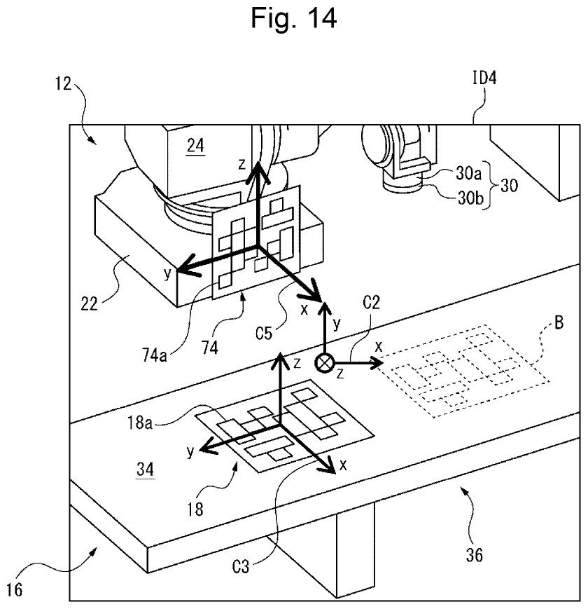

Then, the operator operates the input device 88 of the terminal device 72 and thereby causes the camera 14 to operate and to image the first index and the second index 74. FIG. 14 illustrates an example of image data ID4 imaged with the camera 14 in step S14. In the image data ID4, the second index 74 is captured together with the first index 18 after the transport in step S13. The camera 14 acquires the image data ID4 (second image data) obtained by imaging the transported first index 18 and the second index 74, and supplies the image data ID4 to the processor 80.

Note that in the case in which the terminal device 72 is fixed at the same imaging position PS3=PS4 as a definite point by using the fixture in steps S11 and S14, the processor 80 may automatically perform step S14 when receiving the completion signal SG2 described above, and automatically perform imaging of the image data ID4 with the camera 14.

In step S15, the processor 80 functions as the position data acquisition unit 52 (FIG. 9), and acquires position data PD5 (second position data) indicating the three-dimensional position of the first index coordinate system C3 represented by the first index 18 captured in the image data ID4 with respect to the camera 14, similarly to step S12 described above.

To be specific, the processor 80 executes the image analysis program PG1 to acquire coordinates Q7 (X7, Y7, Z7, W7, P7, R7), in the camera coordinate system C2, of the first index coordinate system C3 represented by the first index 18 captured in the image data ID4. The coordinates Q7 indicate a three-dimensional position of the first index coordinate system C3 with respect to the camera 14 at the time of imaging the image data ID4. In this way, the processor 80 acquires the coordinates Q7 as the position data PD5.

Further, the processor 80 functions as the position data acquisition unit 52, and acquires position data PD6 (fourth position data) indicating a three-dimensional position of the second index coordinate system C5 represented by the second index 74 captured in the image data ID4 with respect to the camera 14. To be specific, the processor 80 executes the image analysis program PG1 to acquire coordinates Q8 (X8, Y8, Z8, W8, P8, R8), in the camera coordinate system C2, of the second index coordinate system C5 represented by the second index 74 captured in the image data ID4.

The coordinates Q8 indicate a three-dimensional position of the second index coordinate system C5 with respect to the camera 14 at the time of imaging the image data ID4. The processor 80 acquires the coordinates Q8 as the position data PD6. In this way, in step S15, the processor 80 acquires the position data PD6 of the second index coordinate system C5 together with the position data PD5 of the first index coordinate system C3.

In step S16, the processor 80 functions as the transport direction acquisition unit 54 (FIG. 9) and determines the transport direction D1 based on pieces of position data PD3, PD4, PD5, and PD6. To be specific, the processor 80 determines a positional relationship R_{3_5_1} (first positional relationship) between the first index coordinate system C3 and the second index coordinate system C5 that have been represented in the camera coordinate system C2 of the image data ID3 (FIG. 12) based on the position data PD3 of the first index coordinate system C3 (i.e., the coordinates Q5 of the camera coordinate system C2) and the position data PD4 of the second index coordinate system C5 (i.e., the coordinates Q6 of the camera coordinate system C2) that have been acquired in the above-described step S12.

Here, the positional relationship R_{3_5_1} between the first index coordinate system C3 and the second index coordinate system C5 in a three-dimensional space defined by the camera coordinate system C2 of the image data ID3 is known from the pieces of position data PD3 and PD4. The processor 80 acquires, from the pieces of position data PD3 and PD4, coordinates Q9 (X9, Y9, Z9, W9, P9, R9) of the first index coordinate system C3 in the second index coordinate system C5 illustrated in FIG. 12 as the data of the positional relationship R_{3_5_1}.

Similarly, the processor 80 determines a positional relationship R_{3_5_2} (second positional relationship) between the first index coordinate system C3 and the second index coordinate system C5 that have been represented in the camera coordinate system C2 of the image data ID4 (FIG. 14) based on the position data PD5 of the first index coordinate system C3 (i.e., the coordinates Q7 of the camera coordinate system C2) and the position data PD6 of the second index coordinate system C5 (i.e., the coordinates Q8 of the camera coordinate system C2) that have been acquired in the above-described step S15. To be specific, the processor 80 acquires, as data of the positional relationship R_{3_5_2} from the pieces of position data PD5 and PD6, coordinates Q10 (X10, Y10, Z10, W10, P10, R10) of the first index coordinate system C3 in the second index coordinate system C5 illustrated in FIG. 14.

Then, the processor 80 calculates a vector VT_{9_10} from the coordinates (X9, Y9, Z9) among the coordinates Q9 to the coordinates (X10, Y10, Z10) among the coordinates Q10. The vector VT_{9_10} coincides with the axis A3 connecting the coordinates (X9, Y9, Z9) and the coordinates (X10, Y10, Z10), and indicates a position of the vector (i.e., the axis A3) of the transport direction D1 in the second index coordinate system C5.

The vector VT_{9_10} (or the axis A3) is expressed as coordinates (or a function) in the second index coordinate system C5, indicates a locus in the second index coordinate system C5 of the origin of the first index coordinate system C3 moved in the transport direction D1 in step S13, and can be regarded as being arranged on the transport surface 34. In this way, the processor 80 acquires the vector VT_{9_10} (or the axis A3) in the second index coordinate system C5 as the transport direction D1.

After step S16 is completed, the processor 80 supplies, to the controller 20, the data of the transport direction D1 acquired in step S15 (to be specific, the data of the coordinates or function of the vector VT_{9_10} or the axis A3 in the second index coordinate system C5). When the processor 40 of the controller 20 receives the data of the transport direction D1, the processor 40 performs step S17.

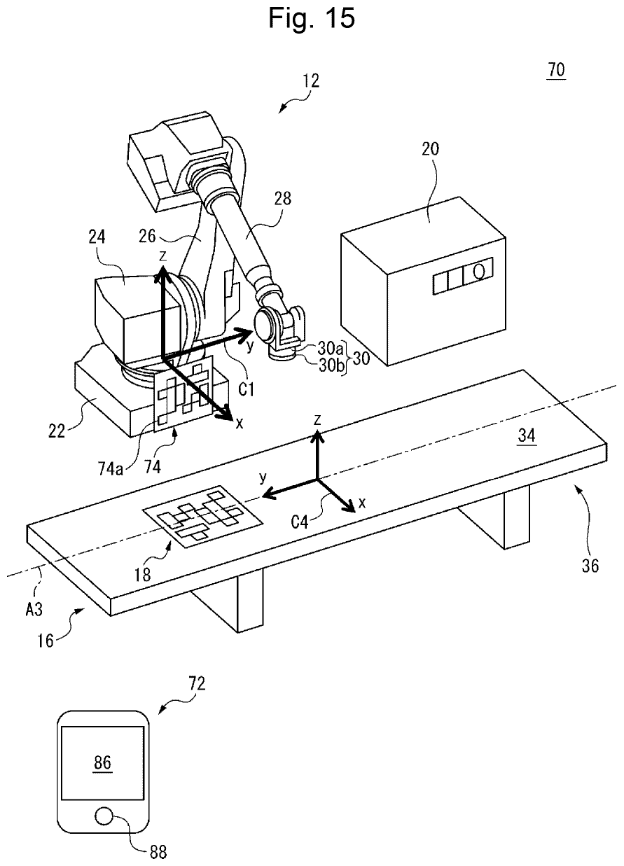

In step S17, the processor 40 functions as the coordinate system setting unit 56 (FIG. 9) and sets the transport device coordinate system C4 (FIG. 15) in the robot coordinate system C1 based on the transport direction D1 determined in step S16. To be specific, the processor 40 converts the transport direction D1 (e.g., the vector VT_{9_10}) determined as the coordinates (or function) of the second index coordinate system C5 in step S16 into the robot coordinate system C1 by using the known positional relationship R_{1_5} (to be specific, the conversion matrix M_{1_5}) between the second index coordinate system C5 and the robot coordinate system C1.

Then, similarly to step S7 described above, the processor 40 determines the transport direction D1 (vector VT_{9_10}) converted into the robot coordinate system C1 as the y-axis positive direction of the transport device coordinate system C4. Thereafter, similarly to the above-described step S7, the processor 40 individually determines the x-axis positive direction and the z-axis positive direction of the transport device coordinate system C4.

In addition, the processor 40 determines the origin of the transport device coordinate system C4 in the robot coordinate system C1. As an example, the processor 40 converts the above-described coordinates Q9 (X9, Y9, Z9) into coordinates C9′ (X9′, Y9′, Z9′) in the robot coordinate system C1, and determines the coordinates C9′ as the origin of the transport device coordinate system C4. As another example, the processor 40 may convert the above-described coordinates Q10 (X10, Y10, Z10) into coordinates C10′ (X10′, Y10′, Z10′) in the robot coordinate system C1, and may determine the coordinates C10′ as the origin of the transport device coordinate system C4.

As still another example, the processor 40 may convert the axis A3 determined as the coordinates (or function) of the second index coordinate system C5 in the above-described step S16 into the robot coordinate system C1, and may determine the origin of the transport device coordinate system C4 as a predetermined position on the axis A3 in the robot coordinate system C1. In this way, as illustrated in FIG. 15, the transport device coordinate system C4 is set in the robot coordinate system C1.

As described above, in the present embodiment, the processor 80 of the terminal device 72 functions as the position data acquisition unit 52 and the transport direction acquisition unit 54, while the processor 40 of the controller 20 functions as the coordinate system setting unit 56. Then, the processors 40 and 80 cooperate with each other to set the transport device coordinate system C4 in the robot coordinate system C1 based on the pieces of image data ID3 and ID4 obtained by imaging the first index 18 and the second index 74 with the camera 14. Therefore, the camera 14, the first index 18, the position data acquisition unit 52, the transport direction acquisition unit 54, the coordinate system setting unit 56, and the second index 74 constitute a device 100 (FIG. 9) that sets the transport device coordinate system C4 in the robot coordinate system C1.

In the device 100, the second index 74 representing the second index coordinate system C5 is placed at a known position in the robot coordinate system C1, and the camera 14 acquires the first image data ID3 obtained by imaging the first index 18 and the second index 74 and the second image data ID4 obtained by imaging the first index 18 and the second index 74 transported in step S13 (steps S11 and S14).

Further, the position data acquisition unit 52 (processor 80) acquires the third position data PD4 (to be specific, coordinates Q6) indicating the three-dimensional position of the second index coordinate system C5 represented by the second index 74 captured in the first image data ID3 with respect to the camera 14 (camera coordinate system C2) (step S12). Next, the position data acquisition unit 52 acquires the fourth position data PD6 (to be specific, the coordinates Q8) indicating the three-dimensional position of the second index coordinate system C5 represented by the second index 74 captured in the second image data ID4 with respect to the camera 14.

Then, the transport direction acquisition unit (processor 80) determines the transport direction D1 in the robot coordinate system C1 based on the first position data PD3 (coordinates Q5), the second position data PD5 (coordinates Q7), the third position data PD4 (coordinates Q6), and the fourth position data PD6 (coordinates Q8) (step S16).

With this configuration, the transport device coordinate system C4 can be set in the robot coordinate system C1 only by imaging the first index 18 and the second index 74 with the camera 14. According to this, it is possible to easily perform setting (i.e., calibration) of the transport device coordinate system C4 in the robot coordinate system C1.

In addition, in the device 100, the transport direction acquisition unit 54 determines the first positional relationship R_{3_5_1} (specifically, the coordinates Q9) between the first index coordinate system C3 and the second index coordinate system C5 in the first image data ID3 (FIG. 12) based on the first position data PD3 and the third position data PD4 (step S16).

Moreover, based on the second position data PD5 and the fourth position data PD6, the transport direction acquisition unit 54 determines the second positional relationship R_{3_5_2} (specifically, the coordinates Q10) between the first index coordinate system C3 and the second index coordinate system C5 in the second image data ID4 (FIG. 14) (step S16).

Then, the transport direction acquisition unit 54 determines the transport direction D1 based on the first positional relationship R_{3_5_1} and the second positional relationship R_{3_5_2} (step S16). With this configuration, it is possible to quickly and accurately determine the transport direction D1 by using an existing algorithm (to be specific, the image analysis program PG1 or the like).

Further, in the device 100, the second index 74 includes the pattern 74a representing a three-dimensional position of the second index coordinate system C5 in the camera coordinate system C2 set for the camera 14 that has performed imaging of the pieces of image data ID3 and ID4. With this configuration, the second index coordinate system C5 can be more effectively represented in the camera coordinate system C2 by the pattern 74a of the second index 74 captured in the pieces of image data ID3 and ID4.

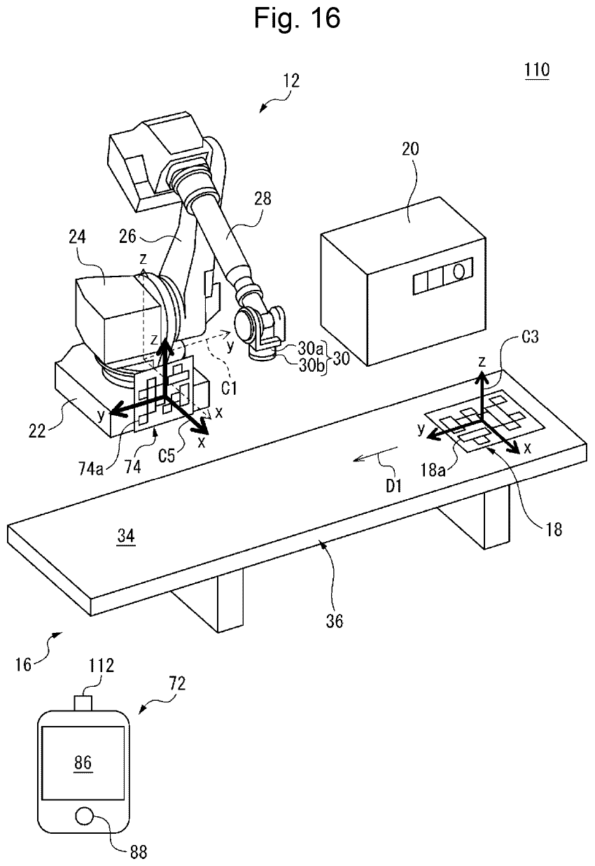

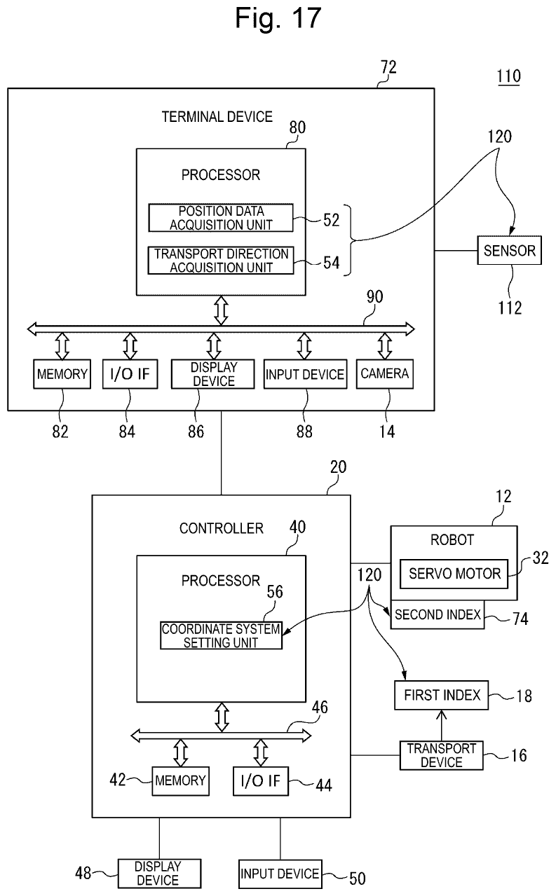

Next, a robot system 110 according to still another embodiment will be described with reference to FIG. 16 and FIG. 17. The robot system 110 is different from the above-described robot system 70 in that the robot system 110 further includes a sensor 112. The sensor 112 detects a displacement A of the camera 14.

More specifically, the sensor 112 includes at least one of a gyro sensor and an acceleration sensor, and is provided in the terminal device 72 so as to be fixed to the camera 14. In the present embodiment, the sensor 112 is communicably connected to the I/O interface 84 of the terminal device 72, detects the displacement Δ of a position (more specifically, a displacement amount and a displacement direction of a position and an orientation) of the camera 14 (i.e., the terminal device 72), and supplies the displacement Δ to the processor 80.

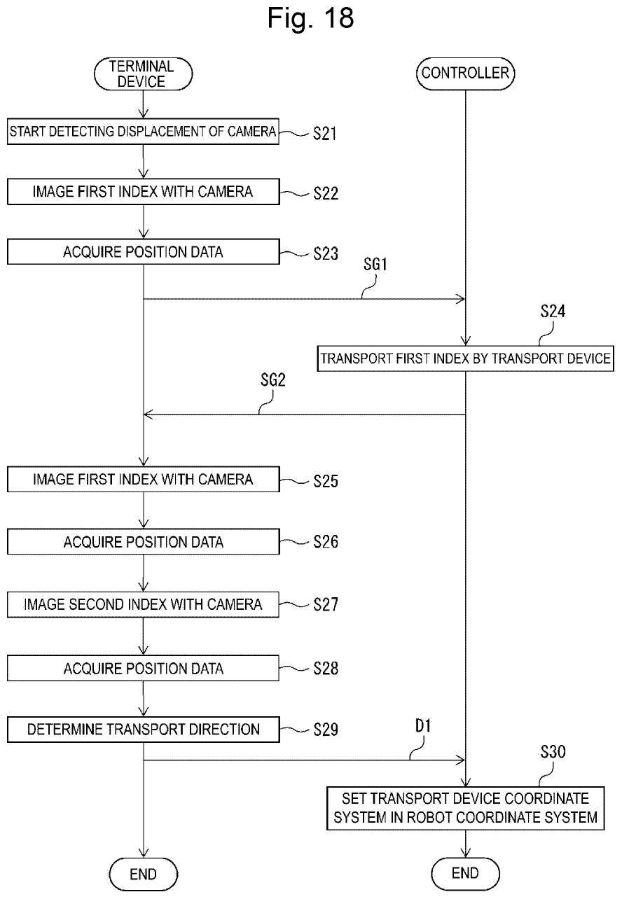

Next, a method in which the transport device coordinate system C4 is set in the robot coordinate system C1 in the robot system 110 will be described with reference to FIG. 18. As in the above-described embodiment, the operator places the first index 18 on the transport surface 34 of the transport device 16 before starting the procedure of FIG. 18.

In step S21, the processor 80 of the terminal device 72 starts detecting the displacement A of the camera 14 by using the sensor 112. Specifically, the processor 80 causes the sensor 112 to operate and to continuously (e.g., periodically) detect the displacement A of the position of the camera 14 (or the terminal device 72). The processor 80 sequentially acquires detection data of the displacement A from the sensor 112 and stores the detection data in the memory 42.

In step S22, the processor 80 images the first index 18 with the camera 14. To be specific, the operator arranges the terminal device 72 at an imaging position PS5 at which the first index 18 can be included in the field of view of the camera 14 of the terminal device 72. At this time, the processor 80 may perform the live view display described above.

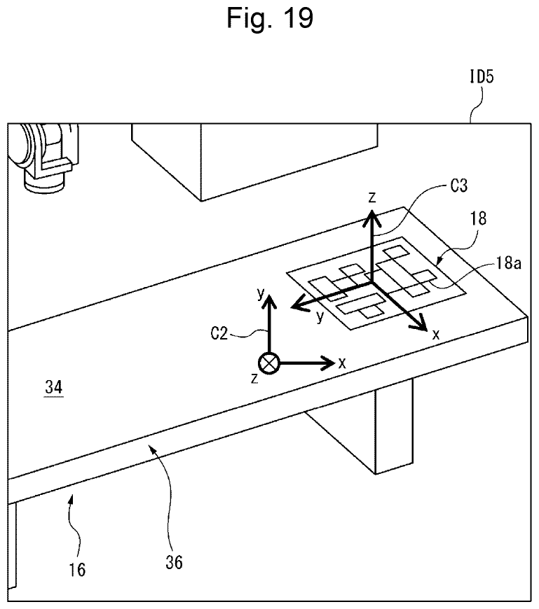

Then, the operator operates the input device 88 of the terminal device 72 to cause the camera 14 to operate and to image the first index 18. FIG. 19 illustrates an example of image data ID5 imaged with the camera 14 in step S22. The camera 14 acquires the image data ID5 (first image data) obtained by imaging the first index 18 in this way, and supplies the image data ID5 to the processor 80.

In step S23, the processor 80 functions as the position data acquisition unit 52 (FIG. 17) and acquires position data PD7 (first position data) indicating the three-dimensional position of the first index coordinate system C3 represented by the first index 18 captured in the image data ID5 with respect to the camera 14. To be specific, as in the above-described embodiment, the processor 80 executes the image analysis program PG1 to acquire, as the position data PD7, coordinates Q11 (X11, Y11, Z11, W11, P11, R11) of the first index coordinate system C3 in the camera coordinate system C2 of FIG. 19. Upon completion of step S23, the processor 80 transmits the completion signal SG1 to the controller 20.

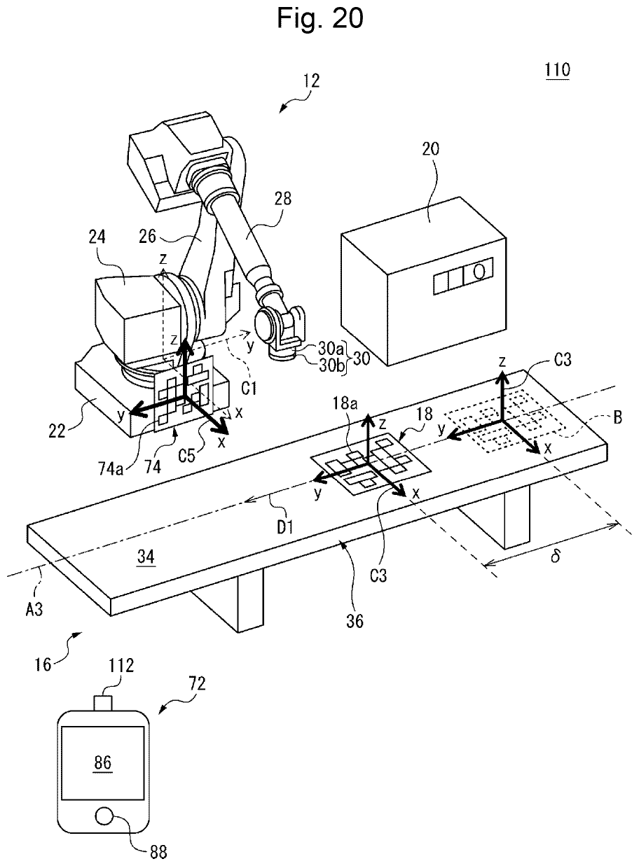

The processor 40 of the controller 20 performs step S24 in response to the completion signal SG1. To be specific, in step S24, the processor 40 causes the transport device 16 to operate and to transport the first index 18 by the distance δ in the transport direction D1, as in step S13 described above. A state in which this step S24 has been completed is illustrated in FIG. 20. Note that in FIG. 20, for ease of understanding, the position of the first index 18 at the time of imaging the image data ID5 is indicated by a dotted line B, and the first index coordinate system C3 represented by the first index 18 is also illustrated.

After completion of step S24, the processor 40 transmits a completion signal SG2 to the terminal device 72. Upon receiving the completion signal SG2, the processor 80 of the terminal device 72 performs step S25. At this time, similarly to the above-described embodiment, the processor 80 may output a notification signal NS3 notifying that the first index 18 needs to be imaged again with the camera 14.

In step S25, the processor 80 of the terminal device 72 images the first index 18 with the camera 14. To be specific, when the operator recognizes the notification signal NS3 output to the display device 86 (or the speaker of the terminal device 72), the operator arranges the terminal device 72 at an imaging position PS6 at which the first index 18 can be included in the field of view of the camera 14. This imaging position PS6 may be different from or the same as the imaging position PS5 in step S22 described above. Additionally, at this time, the processor 80 may perform the above-described live view display.

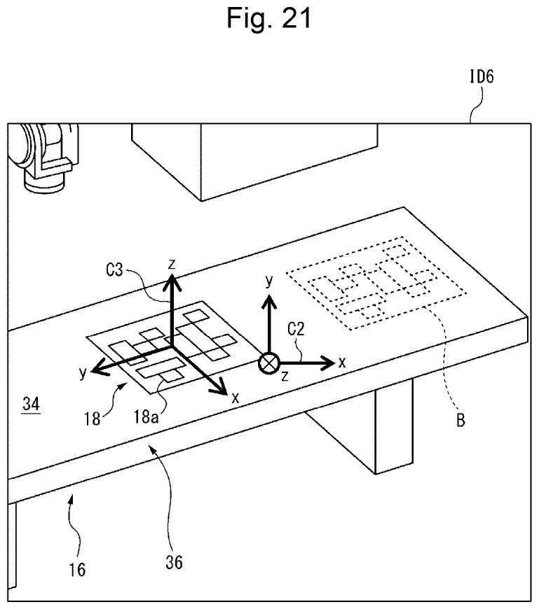

Then, the operator operates the input device 88 of the terminal device 72 to cause the camera 14 to operate and to image the first index 18. FIG. 21 illustrates an example of image data ID6 imaged with the camera 14 in step S25. The camera 14 acquires image data ID6 (second image data) obtained by imaging the transported first index 18, and supplies the image data ID6 to the processor 80.

In step S26, the processor 80 functions as the position data acquisition unit 52 (FIG. 17) and acquires position data PD8 (second position data) indicating the three-dimensional position of the first index coordinate system C3 represented by the first index 18 captured in the image data ID6 with respect to the camera 14. To be specific, the processor 80 executes the image analysis program PG1 as in the above-described step S23, thereby acquiring coordinates Q12 (X12, Y12, Z12, W12, P12, R12) of the first index coordinate system C3 in the camera coordinate system C2 illustrated in FIG. 21 as the position data PD8.

In step S27, the processor 80 images the second index 74 with the camera 14. To be specific, the operator arranges the terminal device 72 at an imaging position PS7 at which the second index 74 can be included in the field of view of the camera 14 of the terminal device 72. The imaging position PS7 is different from the imaging positions PS5 and PS6 described above. At this time, the processor 80 may perform the live view display described above.

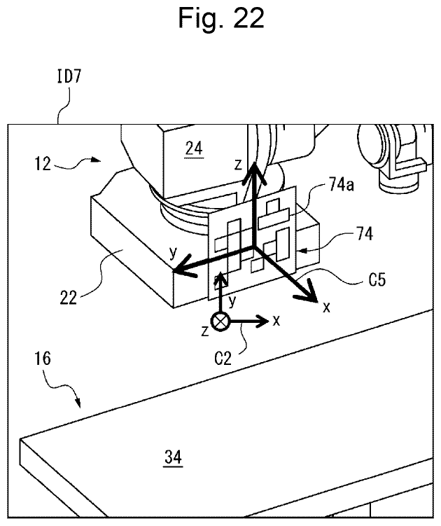

Then, the operator operates the input device 88 of the terminal device 72 to cause the camera 14 to operate and to image the second index 74. FIG. 22 illustrates an example of image data ID7 imaged with the camera 14 in step S27. The camera 14 acquires the image data ID7 (third image data) obtained by imaging the second index 74 and supplies the image data ID7 to the processor 80. As described above, in the present embodiment, the operator separately images the first index 18 and the second index 74 in steps S22 and S25 and step S27.

In step S28, the processor 80 functions as the position data acquisition unit 52 (FIG. 17), and acquires position data PD9 (third position data) indicating a three-dimensional position of the second index coordinate system C5 represented by the second index 74 captured in the image data ID7 with respect to the camera 14. To be more specific, as in the above-described embodiment, the processor 80 executes the image analysis program PG1 to acquire, as the position data PD9, coordinates Q13 (X13, Y13, Z13, W13, P13, R13) of the second index coordinate system C5 in the camera coordinate system C2 of FIG. 22.

In step S29, the processor 80 determines the transport direction D1 based on the pieces of position data PD7, PD8, and PD9 and the displacement Δ detected by the sensor 112. Here, after the start of step S21, the sensor 112 continuously detects the displacement Δ of the camera 14 (the terminal device 72) during imaging of the image data ID5 in step S22, the image data ID6 in step S25, and the image data ID7 in step S27.

Therefore, the processor 80 can determine a displacement Δ_{5_6} from the imaging position PS5 at which the image data ID5 is imaged in step S22 to the imaging position PS6 at which the image data ID6 is imaged in step S25, and a displacement Δ_{6_7} from the imaging position PS6 to the imaging position PS7 at which the image data ID7 is imaged in step S27, from the detection data of the sensor 112.

Based on the displacements Δ_{5_6} and Δ_{6_7}, the position data PD7 (coordinates Q11) acquired in step S23, and the position data PD9 (coordinates Q13) acquired in step S27, the processor 80 can determine a positional relationship R_{3_5_3} between the first index coordinate system C3 and the second index coordinate system C5 before the transport in step S24. To be specific, the processor 80 acquires, as data of the positional relationship R_{3_5_3}, coordinates Q14 (X14, Y14, Z14, W14, P14, R14) of the first index coordinate system C3 before the transport in the second index coordinate system C5.

In addition, the processor 80 can determine a positional relationship R_{3_5_4} between the first index coordinate system C3 and the second index coordinate system C5 after the transport in step S24 from the displacement Δ_{6_7}, the position data PD8 (coordinates Q12) acquired in step S26, and the position data PD9 (coordinates Q13) acquired in step S27. To be specific, the processor 80 acquires, as data of the positional relationship R_{3_5_4}, coordinates Q15 (X15, Y15, Z15, W15, P15, R15) of the first index coordinate system C3 after the transport in the second index coordinate system C5.

Then, the processor 80 calculates a vector VT_{14_15} from the coordinates (X14, Y14, Z14) among the coordinates Q14 to the coordinates (X15, Y15, Z15) among the coordinates Q15. The vector VT_{14_15} coincides with the axis A3 connecting the coordinates (X14, Y14, Z14) and the coordinates (X15, Y15, Z15), and indicates the position of the vector (i.e., the axis A3) of the transport direction D1 in the second index coordinate system C5.

The vector VT_{14_15} (or the axis A3) is expressed as coordinates (or a function) of the second index coordinate system C5, indicates a locus in the second index coordinate system C5 of the origin of the first index coordinate system C3 moved in the transport direction D1 in step S24, and can be regarded as being arranged on the transport surface 34. In this way, the processor 80 acquires the vector VT_{14_15} (or the axis A3) in the second index coordinate system C5 as the transport direction D1.

After completion of step S29, as in the above-described embodiment, the processor 80 supplies, to the controller 20, the data of the transport direction D1 acquired in step S29 (to be specific, the data of the coordinates or function of the vector VT_{14_15} or the axis A3 in the second index coordinate system C5). When the processor 40 of the controller 20 receives the data of the transport direction D1, the processor 40 performs step S30.

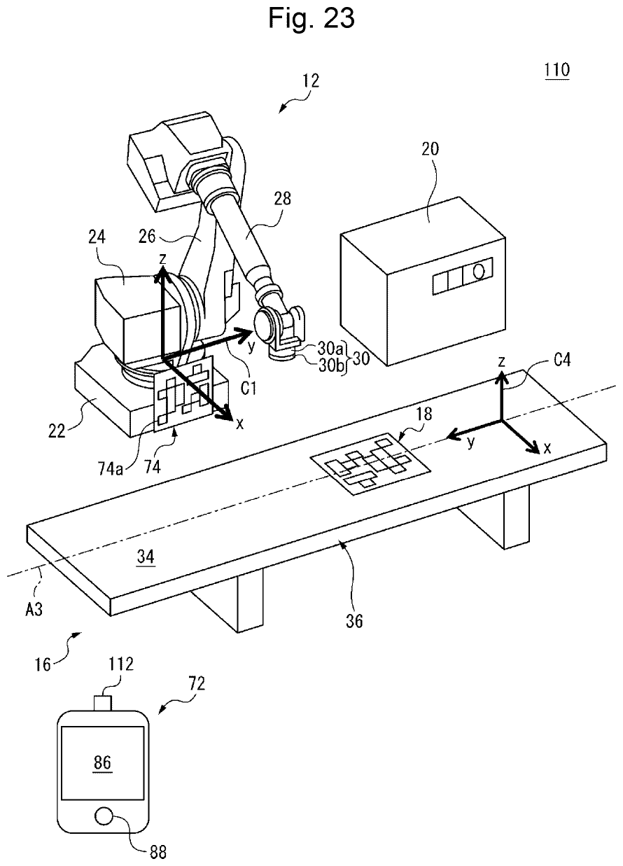

In step S30, the processor 40 functions as the coordinate system setting unit 56 (FIG. 17) and sets the transport device coordinate system C4 (FIG. 23) in the robot coordinate system C1 based on the transport direction D1 determined in step S29. To be specific, similarly to the above-described step S17, the processor 40 uses the known positional relationship R_{1_5} between the second index coordinate system C5 and the robot coordinate system C1 to convert the transport direction D1 (e.g., the vector VT_{14_15}) determined as the coordinates (or function) of the second index coordinate system C5 in step S29 into the robot coordinate system C1.

Then, similarly to the above-described embodiment, the processor 40 determines the transport direction D1 (vector VT_{14_15}) converted into the robot coordinate system C1 as the y-axis positive direction of the transport device coordinate system C4, and individually determines the x-axis positive direction and the z-axis positive direction of the transport device coordinate system C4.

In addition, the processor 40 determines the origin of the transport device coordinate system C4 in the robot coordinate system C1. As an example, the processor 40 converts the above-described coordinates Q14 (X14, Y14, Z14) into coordinates C14′ (X14′, Y14′, Z14′) of the robot coordinate system C1, and determines the coordinates C14′ as the origin of the transport device coordinate system C4. As another example, the processor 40 may convert the above-described coordinates Q15 (X15, Y15, Z15) into coordinates C15′ (X15′, Y15′, Z15′) of the robot coordinate system C1, and may determine the coordinates C15′ as the origin of the transport device coordinate system C4.

As still another example, the processor 40 may convert the axis A3 determined as the coordinates (or function) of the second index coordinate system C5 in the above-described step S29 into the robot coordinate system C1, and may determine the origin of the transport device coordinate system C4 as a predetermined position on the axis A3 in the robot coordinate system C1. Thus, as illustrated in FIG. 23, the transport device coordinate system C4 is set in the robot coordinate system C1.

As described above, in the present embodiment, the processors 40 and 80 cooperate with each other to function as the position data acquisition unit 52, the transport direction acquisition unit 54, and the coordinate system setting unit 56, and set the transport device coordinate system C4 in the robot coordinate system C1 based on the pieces of image data ID5, ID6, and ID7 obtained by imaging the first index 18 and the second index 74 with the camera 14 and the displacement A detected by the sensor 112. Therefore, the camera 14, the first index 18, the position data acquisition unit 52, the transport direction acquisition unit 54, the coordinate system setting unit 56, the second index 74, and the sensor 112 constitute a device 120 (FIG. 17) that sets the transport device coordinate system C4 in the robot coordinate system C1.

In the device 120, the camera 14 acquires the third image data ID3 obtained by imaging the second index 74 (step S27) together with the first image data ID5 (step S22) and the second image data ID6 (step S25) that have been obtained by imaging the first index 18. Then, the position data acquisition unit 52 (processor 80) acquires third position data PD9 indicating a three-dimensional position of the second index coordinate system C5 represented by the second index 74 captured in the third image data ID3 with respect to the camera 14 (camera coordinate system C2) (step S28).

Additionally, the sensor 112 detects displacements Δ_{5_6} and Δ_{6_7} of the camera 14 during imaging of the first image data ID5, the second image data ID6, and the third image data ID7. Then, the transport direction acquisition unit 54 determines the transport direction D1 based on the first position data PD7, the second position data PD8, the third position data PD9, and the displacements Δ_{5_6} and Δ_{6_7} (step S29).

Here, as illustrated in FIG. 12 and FIG. 14, there may be a case in which the camera 14 cannot image the first index and the second index 74 at the same time due to restrictions on the space of the work cell. According to the present embodiment, as illustrated in FIG. 19, FIG. 21, and FIG. 22, even when the first index and the second index 74 are separately imaged, the transport direction D1 can be determined. Therefore, even when there is no room in the space of the work cell, the transport device coordinate system C4 can be effectively set in the robot coordinate system C1.

Note that in the above-described procedure illustrated in FIG. 3, FIG. 11, or FIG. 18, the case has been described in which the processor 40 or 80 images the first index 18 with the camera 14 before and after the first index 18 is transported only once by the transport device 16, and determines the transport direction D1. However, the present disclosure is not limited thereto, and the processor 40 or 80 may determine the transport direction D1 a plurality of times by transporting the first index 18 a plurality of times by the transport device 16 and imaging the first index 18 with the camera 14 before and after the transport.

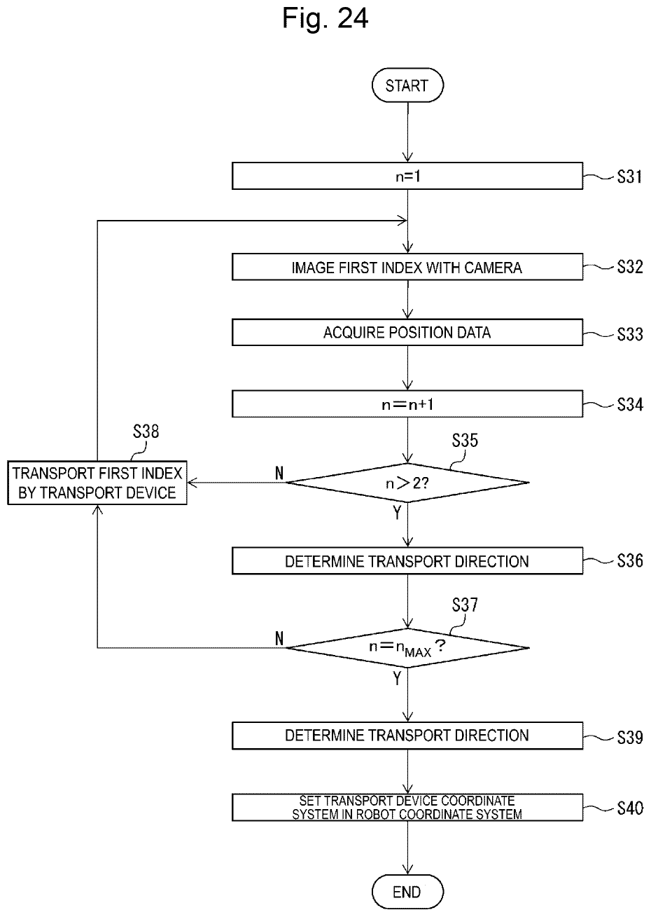

Such an embodiment will be described below with reference to FIG. 24. The flowchart of FIG. 24 illustrates a procedure of another method of setting the transport device coordinate system C4 in the robot coordinate system C1 in the robot system 10 described above. In step S31, the processor 40 sets a number “n” indicating the number of times of imaging the first index 18 in step S32, which will be described later, to “1” (n=1).

In step S32, the processor 40 images the first index 18 with the camera 14. Specifically, the processor 40 causes the robot 12 to operate and to arrange the camera 14 at an imaging position PSn at which the first index 18 can fall within the field of view of the camera 14. Then, the processor 40 causes the camera 14 to operate and to image the first index 18, thereby acquiring image data IDn as illustrated in FIG. 4 or FIG. 6, for example. If the number “n” is set to n=1 at the start of this step S32, the processor 40 images the image data ID1 with the camera 14 arranged at the imaging position PS1.

In step S33, as in step S2 or S5 described above, the processor 40 functions as the position data acquisition unit 52 (FIG. 2) to acquire position data PDn (to be specific, coordinates Qn of the camera coordinate system C2) indicating a three-dimensional position of the first index coordinate system C3 represented by the first index 18 captured in the image data IDn with respect to the camera 14.

If the number “n” is set to n=1 at the start of this step S33, the processor 40 acquires the position data PD1 indicating the three-dimensional position of the first index coordinate system C3 represented in the image data ID1 with respect to the camera 14 (specifically, the coordinates Q1 of the camera coordinate system C2). In step S34, the processor 40 increments the number “n” by “1” (n=n+1).

In step S35, the processor 40 determines whether or not the number “n” satisfies n>2. The processor 40 proceeds to step S36 when determining YES, and proceeds to step S38 when determining NO. If the procedure proceeds to step S35 after performing step S32 for the first time (i.e., in a state in which n=1 is set), the number “n” at this timing has been incremented to n=2 in step S34. Therefore, in this case (i.e., when the first index 18 is imaged only once), the processor 40 determines NO in step S35, and proceeds to step S38.

In step S36, the processor 40 functions as the transport direction acquisition unit 54 (FIG. 2) as in step S6 described above, and determines the transport direction D1_{_n} based on the position data PDn (specifically, the coordinates Qn) acquired in step S33 performed most recently and the position data PDn−1 (specifically, the coordinates Qn−1) acquired in step S33 performed before acquiring the position data PDn.

Here, in the flowchart illustrated in FIG. 24, the processor 40 repeatedly performs a loop of steps S32 to S38 until determining YES in step S37, which will be described later. Therefore, the processor 40 repeatedly transports the first index 18 by the transport device 16 in step S38, which will be described later, and acquires the position data PDn−1 (first position data) in step S33 performed before the transport from the image data IDn−1 (first image data) imaged in step S32 before the transport. On the other hand, the processor 40 acquires the position data PDn (second position data) in step S33 performed after the transport from the image data IDn (second image data) imaged in step S32 after the transport.

In step S36, the processor 40 determines the transport direction D1_{_n} (e.g., the vector VT_{_n} similar to the vector VT_{3_4} described above) based on the position data PDn (second position data) acquired in step S33 performed most recently and the position data PDn−1 (first position data) acquired in step S33 performed before acquiring the position data PDn in a manner similar to step S6 described above.

In step S37, the processor 40 determines whether or not the number “n” has reached n=n_{MAX}. This number n_{MAX} indicates a maximum number of imaging the first index 18 in step S32 (e.g., n_{MAX}=10), and is predetermined by the operator. The processor 40 proceeds to step S39 when determining YES, and proceeds to step S38 when determining NO.

In step S38, the processor 40 transports the first index 18 by using the transport device 16 as in step S3 described above. Note that the processor 40 may transport the first index 18 in the transport direction D1 in the n-th step S38, and transport the first index 18 in an opposite direction D2 to the transport direction D1 by the transport device 16 in the (n+1)-th step S38 performed thereafter.

In step S36, which is performed after the transport in the opposite direction D2, the processor 40 calculates the vector VT_{_n}′ in the opposite direction D2 from the pieces of position data PDn−1 and PDn. In this case, the processor 40 may determine a vector VT_{_n} in a direction opposite to the vector VT_{_n}′ as the transport direction D1_{_n}. Thus, the processor 40 repeatedly performs the loop of steps S32 to S38 until determining YES in step S37, and determines the transport direction D1_{_n} every time step S36 is performed.

In step S39, the processor 40 functions as the transport direction acquisition unit 54 to determine the final transport direction D1_{_F}. To be specific, the processor 40 determines a composite vector VT_{_F} (or an average vector) of a plurality of vectors VT_{_1}, VT_{_2}, . . . , VT_{_n} acquired as the transport direction D1_{_n} every time step S36 is performed, and acquires the vector VT_{_F} as the final transport direction D1_{_F}.

In step S40, the processor 40 functions as the coordinate system setting unit 56 (FIG. 2), and sets the transport device coordinate system C4 in the robot coordinate system C1 based on the transport direction D1_{_F} acquired in step S39 as in the above-described step S6. To be specific, the processor 40 determines the vector VT_{_F} determined in step S39 as the y-axis positive direction of the transport device coordinate system C4.

As described above, in the present embodiment, the processor 40 determines the transport direction D1_{_n} every time the first index 18 is transported a plurality of times by the transport device 16, and acquires the final transport direction D1_{_F} based on the plurality of determined transport directions D1_{_n}. With this configuration, the transport direction D1 of the transport device 16 can be determined with higher accuracy.

It should be understood that the concept of the procedure of FIG. 24 (i.e., determining the transport direction D1_{_n} every time the transport device 16 transports the first index 18 a plurality of times and acquiring the final transport direction D1_{_F} based on the plurality of transport directions D1_{_n}) can be applied to the procedure of FIG. 11 or FIG. 18. For example, in the case of the procedure of FIG. 11, the processors 40 and 80 may cooperate with each other to repeatedly perform the loop of steps S11 to S16, and determine the final transport direction D1_{_F} based on the plurality of transport directions D1_{_n} individually determined for each time step S16 is performed.

Additionally, in the case of the procedure of FIG. 18, the processor 80 of the terminal device 72 performs step S27 and step S28 after step S21. Thereafter, the processors 40 and 80 may cooperate with each other to repeatedly perform the loop of steps S22 to S26 and S29, and may determine the final transport direction D1_{_F} based on the plurality of transport directions D1_{_n} determined for each time step S29 is performed.

Note that in the above-described embodiment, the case has been described in which the second index 74 includes the pattern 74a representing the second index coordinate system C5 in the camera coordinate system C2. However, the second index 74 is not limited to this, and may be constituted by using a shape 74b of the robot 12. As an example, the shape 74b may be constituted by a plurality of surfaces, edges, recesses and protrusions formed at a component of the robot 12 (e.g., the robot base 22). As another example, the shape 74b may be constituted by the shape of the entire robot 12 (i.e., the robot base 22, the swivel body 24, the lower arm 26, the upper arm 28, the wrist 30, and the wrist flange 30b) being stationary at a predetermined position.

In the present embodiment, when the camera 14 images the shape 74b serving as the second index 74 in the above-described step S11, S14, or S27, the shape 74b captured in the imaged image data ID represents the three-dimensional position (i.e., the coordinates Q) of the second index coordinate system C5 in the camera coordinate system C2 of the camera 14.

Then, in the above-described step S12, S15 or S28, the processor 40 or 80 functions as the position data acquisition unit 52, executes the image analysis program PG2 (image analysis application) for reading the second index coordinate system C4 from the shape 74b, and specifies the second index coordinate system C4 represented by the shape 74b in the image data ID.

After that, the processor 40 or 80 acquires, as the position data PD, the coordinates Q of the specified second index coordinate system C4 in the camera coordinate system C2. Note that the first index 18 may include, instead of the pattern 18a, for example, a shape 18b (surface, edge, recess, protrusion) formed at the transport surface 34.

Note that in the above-described robot system 70 (FIGS. 9) and 110 (FIG. 17) described above, the processor 80 of the terminal device 72 functions as the position data acquisition unit 52 and the transport direction acquisition unit 54. However, in the robot system 70 or 110, the processor 40 of the controller 20 may function as the position data acquisition unit 52, the transport direction acquisition unit 54, and the coordinate system setting unit 56. In this case, the processor 80 of the terminal device 72 supplies the pieces of image data ID3, ID4, ID5, ID6, and ID7 imaged with the camera 14 to the controller 20.

Alternatively, the terminal device 72 may be omitted, and the camera 14 may be constituted by, for example, a digital camera. Then, the operator may transmit the pieces of image data ID3, ID4, ID5, ID6, and ID7 imaged with the camera 14 to the I/O interface 44 of the controller 20 in a wired or wireless manner.

Note that in the above-described step S6, the case has been described in which the processor 40 determines the transport direction D1 as the vector VT_{3_4} from the coordinates Q3 (X3, Y3, Z3) to the coordinates Q4 (X4, Y4, Z4), which indicates the locus of the origin of the first index coordinate system C3. However, the present disclosure is not limited to this, and the processor 40 can also determine the transport direction D1 based on a change amount between the coordinates (W3, P3, Q3) indicating the orientation among the coordinates Q3 and the coordinates (W4, P4, R4) indicating the orientation among the coordinates Q4.

Similarly, in the above-described step S16, S29, or S36, the processor 80 may determine the transport direction D1 based on a change amount of the coordinates Q9 (W9, P9, R9) and the coordinates Q10 (W10, P10, R10) indicating the orientations, a change amount of the coordinates Q14 (W14, P14, R14) and the coordinates Q15 (W15, P15, R15) indicating the orientations, or a change amount of the coordinates Qn−1 and the coordinates Qn indicating the orientations.

Note that the processor 40 or 80 may perform the procedure illustrated in FIG. 3, FIG. 11, FIG. 18, or FIG. 24 according to a computer program PG3 stored in the memory 42 or 82 in advance. In addition, functions of the position data acquisition unit 52, the transport direction acquisition unit 54, and the coordinate system setting unit 56 that are to be performed by the processor 40 or 80 may be functional modules that are to be implemented by the computer program PG3.

Alternatively, the controller 20 may include a first controller 20A configured to control the robot 12 and a second controller 20B configured to control the transport device 16. Further, the robot 12 is not limited to being the vertical articulated robot, and may be any other type of robot, such as a horizontal articulated robot, or a parallel link robot. Further, the transport device 16 is not limited to a belt conveyor, and may be any device capable of transporting a workpiece. Although the present disclosure has been described through embodiments above, the embodiments described above do not limit the scope of the invention claimed in the claims.

### Reference Signs List

10, 70, 110 Robot system
12 Robot
14 Camera
16 Transport device
18 First index
20 Controller
40, 80 Processor
52 Position data acquisition unit
54 Transport direction acquisition unit
56 Coordinate system setting unit
60, 100, 120 Device
74 Second index
112 Sensor

1. A device configured to set a transport device coordinate system in a robot coordinate system set to a robot configured to carry out work on a workpiece, the transport device coordinate system defining a transport direction of a transport device configured to transport the workpiece, the device comprising:
a first index representing a first index coordinate system and placed on the transport device so as to be transported by the transport device;
a camera configured to acquire first image data obtained by imaging the first index, and second image data obtained by imaging the first index transported by the transport device after imaging the first image data;
a position data acquisition unit configured to acquire first position data indicating a three-dimensional position, with respect to the camera, of the first index coordinate system represented by the first index captured in the first image data, and second position data indicating a three-dimensional position, with respect to the camera, of the first index coordinate system represented by the first index captured in the second image data;
a transport direction acquisition unit configured to determine the transport direction, based on the first position data and the second position data; and
a coordinate system setting unit configured to set the transport device coordinate system in the robot coordinate system, based on the transport direction determined by the transport direction acquisition unit.

2. The device of claim 1, further comprising a second index placed on a known position in the robot coordinate system and representing a second index coordinate system,
wherein the camera is configured to acquire the first image data obtained by imaging the first index and the second index, and the second image data obtained by imaging the transported first index and the second index,
wherein the position data acquisition unit is configured to further acquire third position data indicating a three-dimensional position, with respect to the camera, of the second index coordinate system represented by the second index captured in the first image data, and fourth position data indicating a three-dimensional position, with respect to the camera, of the second index coordinate system represented by the second index captured in the second image data, and
wherein the transport direction acquisition unit is configured to determine the transport direction, further based on the third position data and the fourth position data.

3. The device of claim 2, wherein the transport direction acquisition unit is configured to:
determine a first positional relationship between the first index coordinate system and the second index coordinate system in the first image data, based on the first position data and the third position data;
determine a second positional relationship between the first index coordinate system and the second index coordinate system in the second image data, based on the second position data and the fourth position data; and
determine the transport direction, based on the first positional relationship and the second positional relationship.

4. The device of claim 1, comprising:
a second index placed at a known position in the robot coordinate system and representing a second index coordinate system; and
a sensor configured to detect a displacement of the camera,
wherein the camera is configured to further acquire third image data obtained by imaging the second index,
wherein the position data acquisition unit is configured to further acquire third position data indicating a three-dimensional position, with respect to the camera, of the second index coordinate system represented by the second index captured in the third image data,
wherein the sensor is configured to detect the displacement of the camera during imaging the first image data, the second image data, and the third image data, and
wherein the transport direction acquisition unit is configured to determine the transport direction, further based on the third position data and the displacement detected by the sensor.

5. The device of claim 2, wherein the second index includes a pattern or a shape of the robot representing a three-dimensional position of the second index coordinate system in a camera coordinate system set to the camera that images the image data.

6. The device of claim 1, wherein the first index includes a pattern representing a three-dimensional position of the first index coordinate system in a camera coordinate system set to the camera that images the image data.

7. A method of setting a transport device coordinate system in a robot coordinate system set to a robot configured to carry out work on a workpiece, the transport device coordinate system defining a transport direction of a transport device configured to transport the workpiece, the method comprising:
placing a first index representing a first index coordinate system on the transport device so as to be transported by the transport device;
acquiring first image data by imaging the first index with a camera, and acquiring second image data by imaging, with the camera, the first index transported by the transport device after imaging the first image data;
acquiring first position data indicating a three-dimensional position, with respect to the camera, of the first index coordinate system represented by the first index captured in the first image data, and second position data indicating a three-dimensional position, with respect to the camera, of the first index coordinate system represented by the first index captured in the second image data;
determining the transport direction, based on the first position data and the second position data; and
setting the transport device coordinate system in the robot coordinate system, based on the determined transport direction.
